(19) United States
(12) Patent Application Publication
(10) Pub. No.: US 2015/0066524 A1
(43) Pub. Date: Mar. 5, 2015

(54) METHODS AND SYSTEMS FOR THE IMPLEMENTATION OF WEB BASED COLLABORATIVE CLINICAL PATHWAYS

(71) Applicant: Dorsata, Inc., Lebanon, NH (US)

(72) Inventors: David Laughlin Fairbrothers, Arlington, VA (US); Philip Andrew McDonnell, San Francisco, CA (US); Daniel Peter Gibson, St. Louis, MO (US); Colin Steele, Charlottesville, VA (US)

(73) Assignee: DORSATA, INC., Lebanon, NH (US)

(21) Appl. No.: 14/019,433

(22) Filed: Sep. 5, 2013

(51) Int. Cl. G06F 19/00

(52) U.S. Cl. CPC G06F 19/345
USPC 705/2

(57) ABSTRACT

Methods and systems to facilitate the collaborative development, discovery and implementation of evidence-based, clinical pathways are disclosed. Clinicians, medical professionals or researchers, may use the Platform 105 in multiple implementation, such as integrated with a third-party system like an EHR 104 to build and find clinical pathways through a graphical interface, creating relational data records between steps in pathways. Further, users of the Platform 105 may be able to associate relevant content such as published evidence, supplemental content items (e.g., videos, images, documents, ICD, CPT, SNOMED codes, and external web pages), and other associated pathways which reside in the system's database. Users of the Platform 105 may be able organize themselves into groups and networks to develop single pathways collaboratively. Users may be able to find specific pathways in the Platform 105 through semantic search, querying for relationships which exist inside of individual pathways. Search results may be generated for a variety of user driven data, both explicit and implicit.

### FIELD OF THE INVENTION

The present invention relates to computer based medical information systems, and more particularly to systems and methods for creating, managing and utilizing collaborative electronic clinical pathways for patient care.

### BACKGROUND OF THE INVENTION

Clinical Pathways, also known as integrated care pathways, clinical algorithms, multi-disciplinary pathways of care, pathways of care, care maps, and collaborative care pathways are one of the main tools used to manage the quality in healthcare concerning the standardization of care processes. Conventionally, Clinical Pathways reduces the variability in clinical practice and improve outcomes; pathways promote organized and efficient patient care based on the evidence based practice; and optimize outcomes in the acute care and homecare settings. Clinical Pathways are structured, multi-disciplinary plans of care designed to support the implementation of clinical guidelines and protocols. They are designed to support clinical management, clinical and non-clinical resource management, clinical audit and also financial management. They provide detailed guidance for each stage in the management of a patient, treatments, interventions with a specific condition over a given time period, and include progress and outcomes details.

Conventional Clinical Pathways aim to improve, in particular, the continuity and co-ordination of care across different disciplines and sectors and may be viewed as algorithms because they offer a flow chart format of the decisions to be made and the care to be provided for a given patient or patient group for a given condition in a step-wise sequence. Clinical Pathways have four main components: a timeline, the categories of care or activities and their interventions, intermediate and long term outcome criteria, and the variance record (“to allow deviations to be documented and analyzed”). Conventional Clinical Pathways support the introduction of evidence-based medicine and use of clinical guidelines, clinical effectiveness, risk management and clinical audit, improves multidisciplinary communication, teamwork and care planning, provide explicit and well-defined standards for care, the introduction of evidence-based medicine and use of clinical guidelines, clinical effectiveness, risk management and clinical audit, continuity and co-ordination of care across different clinical disciplines and sectors, reduce variations in patient care, improve and even reduce patient documentation, disseminate accepted standards of care; provide a baseline for future initiatives; help reduced risk; and helps reduce costs by shortening hospital stays

Conventional Clinical Pathways may not be readily accessible, appear to discourage personalized care; are typically not prescriptive; may not respond well to unexpected changes in a patient's condition; are best suited for standard conditions rather than unusual or unpredictable ones; may not be tied to clinical outcomes; may take time to be accepted in the workplace; and need to ensure variance and outcomes are properly recorded, audited and acted upon. There is a need for a web-based graphical user interface (“GUI”) platform for medical professionals to collaborate in building decision making clinical pathways, which interacts with Electronic Health Records (“EHR”) systems, supports the association of information used to support each decision or step and support for dynamically updating standard clinical pathways to support unusual or unpredictable conditions. There is a further need for Clinical Pathways that can provide real-time, personalized support to clinician 101s at the point-of-care and during clinical workflows. There is also a need for Clinical Pathways that can reduce the risk of medical service providers delivering care that is not partially or completely covered, or reimbursable by Medicare/Medicaid, or private insurance.

### SUMMARY OF THE INVENTION

The invention provides a web based collaborative clinical pathway platform (“Platform”) for creating, building, maintaining and implementing dynamic or flexible clinical pathways or algorithms.

Embodiments of the present invention may include a computer-implemented method for utilizing dynamic clinical pathways for facilitating clinical order set entry. The method capable of performing at least the following steps of: receiving initial clinical assumption from an electronic health record; receiving physician identifier; querying one or databases using the initial clinical assumption and physician identifier; compile a set of one or more clinical pathways related to the initial clinical assumption and physician identifier; returning the set of one or more clinical pathways to the electronic health record; receiving a chosen pathway from the set of one or more clinical pathways; logging the chosen pathway; receiving choice of a node with the chosen pathway; logging the choice of node; capturing a clinical order set code; if necessary, receiving choices of additional nodes and logging the additional choices of nodes and capturing associated clinical order set codes for the additional choices of nodes until the chosen pathway is complete; and returning a compilation of clinical order set codes.

Embodiments of the present invention may include a computer-implemented method for identifying a patient's previous clinical pathways during a new patient encounter. The method capable of performing at least the following steps of: receiving a request from a third-party system for one or more clinical pathways associated with a first patient encounter, wherein the request contains a token generated by the third-party system; analyzing the token to identify a unique identifier associated with a patient's electronic health records; updating the received request with the identified unique identifier; submitting the updated request to one or more clinical pathway databases; ranking results received from the one or more clinical pathway databases using at least one ranking criteria; and transferring the ranked results to the third party system for display to a user.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is an illustration of a Platform 105 according to one embodiment of the invention.

FIG. 2 is an illustration of the implementation of a Platform 105 with EHR system according to one embodiment of the invention.

FIGS. 3-9 are exemplary illustrations of clinical pathway operations according to one embodiment of the Platform.

FIG. 10 is an exemplary illustration of a clinical pathway chart for Pulmonary Embolism according to one embodiment of the Platform.

FIG. 11 is an exemplary diagram of a diagnostic algorithm for cerebellopontine angle (“CPA”) lesions according to one embodiment of the Platform.

FIGS. 12-23 are exemplary illustrations of operations available for a non-mobile device accessing a clinical pathway according to one embodiment of the invention.

FIGS. 24-32 are exemplary illustrations of operations available for a mobile device accessing a clinical pathway according to one embodiment of the invention.

FIGS. 33A-330 are a schematic chart illustrating exemplary multiple operations of the Platform.

### DETAILED DESCRIPTION OF THE INVENTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical or structural changes may be made to the invention without departing from the spirit or scope of this disclosure. To avoid detail not necessary to enable those skilled in the art to practice the embodiments described herein, the description may omit certain information known to those skilled in the art. The following detailed description is, therefore, not to be taken in a limiting sense.

As used herein, a database may be a relational database, flat file database, relational database management system, object database management system, operational database, data warehouse, hyper media database, post-relational database, hybrid database models, RDF database, graph database, key value database, XML database, XML store, text file, flat file, full text search databases, other online transaction processing and online analytical systems or other type of database.

As used herein, a workflow broadly refers to a path and/or order of steps in which the Collaborative Clinical Pathway Platform 105 may perform a task or a step. The order or number of steps may vary in different embodiments.

As used herein, a computer 102 shall include without limitation desktop computers, notebook computers, netbook computers, personal digital assistants (“PDAs”), mobile phones, servers, handheld computers, cellular phones, and similar devices, including without limitation web enabled devices. As used herein, the terms “Electronic Health Records”, EHR 104, EMR and “Electronic Medical Records” are used interchangeably to refer to EHR 104 systems. As used herein, the terms “clinical pathways”, “pathways” or “clinical algorithms” are used interchangeably to refer to clinical pathways.

In some embodiments, the Collaborative Clinical Pathway platform may be implemented via one or more computers 102 and a web browser. Each computer may be well known to those skilled in the art and may include a display, a central processor, a system memory, and a system bus that couples various system components including the system memory to the central processor unit. The system bus may be any of several types of bus structures including a memory bus or memory controller, a peripheral bus, and a local bus using any of a variety of bus architectures. The structure of system memory may be well known to those skilled in the art and may include a basic input/output system (“BIOS”) stored in a read only memory (“ROM”) and one or more program modules such as operating systems, application programs and program data stored in random access memory (“RAM”). The computers 102 may also include a variety of interface units and drives for reading and writing data and a database for storing data. The computers 102 may run an Operating System (“OS”). The OS may include a shell, for providing transparent user access to resources such as application programs. The OS may include a kernel, which provides essential services required by other parts of OS and application programs. The services provided by the kernel include memory management, process and task management, disk management, and I/O device management. The OS may be the Linux Operating system, Microsoft Operating system or other operating systems.

Each computer may be able to communicate with another computer via a network using a network interface, which is coupled to the system bus. The network may be an external network such as the Internet, or an internal network such as an Ethernet or a Virtual Private Network (“VPN”). The network may also include one or more of a wireless network, a wired network, the Internet, a PSTN, a private network, or any other communication network. The computers that implement the Platform 105 may be implemented on a variety of hardware platforms or implemented in a variety of software environments.

Applications running on or accessing these computers 102 may include a browser 100, a rules engine, a workflow application or other application required by the Platform. A browser may include program modules and instructions for enabling a World Wide Web (“WWW”) client to send and receive network messages to the Internet. The browser may use well known protocols, such as Hypertext Transfer Protocol (“HTTP”) messaging to enable communication with another computer.

Systems and methods are described for the implementation of dynamic and flexible clinical pathways. The examples described herein relate to an implementation of dynamic and flexible clinical pathways with EHR 104 systems. The systems and methods described herein may be used for many different industries and purposes. In particular, the systems and methods may be used for any industry or purpose, which requires clinical pathways. Or the systems and methods may be used for any industry or purpose in which a dynamic, flexible and highly adaptable clinical pathway may be required by a clinician 101 or other individuals associated with the healthcare industry. While use with an EHR 104 is described to show operation of the systems and methods, it is understood that other applications are possible.

The Platform 105 may be of a set of information computation and storage components that enable creation and use of structured diagnostic and treatment pathways. These pathways may be editable, versioned, shared, branched and serve as an automated gateway to medical coding systems such as ICD/SNOMED. Users may access the Platform 105 via web-based applications, native desktop applications, mobile applications on computers 102, or via a third party system such as Electronic Health Records (“EHR”) providers like EPIC or Cerner. In some alternatives, the Platform 105 may be implemented as a multi-tiered application with a presentation tier, a business tier and a data tier. The presentation tier may responsd to end-user requests and renders data derived from the business tier. In some alternatives, the presentation tier may be implemented as a conventional web-based application, wherein the Platform 105 renders HTML for consumption in end-user web browsers. In some alternatives, the presentation tier may be implemented as a thin-client single-page web application written in JavaScript, which may communicate with the Platform 105 to obtain data and may render such data in a web browser dynamically. In some alternatives, the presentation tier may be implemented as proprietary applications, both desktop and mobile, which may obtain data from the Platform 105 and may display such data in native user interfaces. In some alternatives, the presentation tier may be implemented as third-party applications, which may obtain data via the Platform's API and may render the data in forms customized to the given application.

The business tier may coordinate the overall Platform, may process commands from users via the presentation layer, and may make decisions based on proprietary business rules within the Platform. The business tier may enforce rules concerning authentication, authorization and auditing, maintains the consistency and integrity of data in the data tier, and may implements proprietary logic systems and business rules that may enable the Platform 105 to provide its services to end-users. The business tier may include DNS systems; caching/reverse-proxy load balancers; web servers; API servers; web crawling servers; queuing and/or messaging systems; Natural Language Processing (“NLP”) analysis servers; and interfaces to third parties.

The data tier may be implemented on one or more database. For example, the data tier may be implemented in a graph database with one or more vertices. The vertices may include path; path version; node; node version; citation; citation version; comment; attachment; article; article term; organization; user; cohort; status update; coding system; and code. These vertices may provide the following services to users of the Platform: pathway editing with persistence, roll forward and rollback; user choice of pathway version(“s”) to be used; pathway sharing and branching; real-time search by full-text, term(“s”), URL, structured (“Boolean”) query, etc. This vertices data model may allow the expression of pathway evolution via the path vertex. The path vertex may map to the notion of a given line of change for a given diagnostic or treatment pathway. The ordered edges attached to the path may indicate the versions of the pathway, with each edge pointing to a path version vertex. Each time a path is edited, a new Path Version vertex may be added, and an edge from the relevant path to the path version may be added. Properties and/or additional edges on the path version or path to path version edge may include audit data, etc. A path version vertex in turn may have edges for each node version, which may be a component of the pathway for that particular version of the pathway. Each node vertex may contain properties such as a textual description, title, etc., and may have edges for citation, comment, attachment and article vertices. Similarly, a node vertex may have ordered edges to node versions, which may indicate the state of the node as it is edited over time. When a pathway node is edited, a new node version may be created, and an edge from the relevant node to the new node version may be added. A new path version may be created, and the path version to node version edges from the previous path version may be added to it, but not the edge relevant to the newly edited node. Instead of importing that edge from the previous node version, a path version to node version edge may be added, which may point to the newly created node version. Thus, path vertices may be logical pathways, and grouped together path versions, may express the evolution of a pathway over time. Node vertices may be logical node components of pathways, and may group together node versions, capturing the evolution of a pathway node over time. Not all path versions may need to be exposed to end users as discrete “named” versions of a pathway. Similarly, if an attachment, article, comment, citation vertex is modified; this data model may support either the notion that the change creates a new node version of the corresponding node to which the vertex may be related.

The Platform 105 may support real-time search for elements in the database (“principally path, path version, node, node version, and code”) using full text and term search for medical and non-medical terms. The Platform 105 may utilize NLP to extract keywords, key n-gram phrases, entities and to perform relation and concept tagging. These extractions may then be fed into the database as term vertices, and related to the source vertex(“ices”). For example, if a user may create or add a URL to a pathway node, the Platform 105 may creating a new Node Version vertex for the pathway node, a new Path Version for the pathway itself, and relating these new vertices together as described above. The Platform 105 may web-crawl the URL specified as a property on the citation vertex and may obtain the HTML and other contents of the URL. The HTML may be analyzed using NLP technology to extract keywords, entities, etc. These keywords, entities, etc. may then be added back to the database as terms, related to the newly created citation.

The above example is for illustrative purposes only and should not be considered as limiting. It is understood that other implementations of the Platform 105 are possible.

In some embodiments, the Platform may interface with an Electronic Health Record (“EHR”) system using any conventions means, such as application programming interface (“API”) or web service, such as the Representational state transfer (“REST”) web services. In some alternatives, the Platform 105 may be configured to accept incoming HTTP requests from third-party applications, such as the EHR 104 as discussed below in step 204. These requests may be triggered by a user query in the EHR 104. In some alternatives, the interface may be used to automate the input of data from the Platform 105 to the EHR 104. In some alternatives, a user may submit query based on data from an EHR 104 related to a patient encounter, such as demographics, past medical history, medications, lab results or other data to the Platform, which may provide results that may suggest one or more appropriate clinical pathways which are appropriate for management, ideally personalized based on a provider's institution, specialty, prior usage, known patient preferences, etc. In some embodiments of the invention, outcome data on pathway use may be obtained through the interface with the one or more EHR 104 systems. For example, if the user would like to know if the “Dartmouth Hip Pain Pathway” has been used 400 times during the last 6 months at 12 institutions. An interaction with the EHR 104 may provide the following outcome data, 75% of patients were managed non-operatively with an additional 25% of patients undergoing hip replacement surgery with an average cost of $26K per patient. In some alternatives, the user may be able to populate a patient's electronic health record by clicking through a graphical pathway during the course of care.

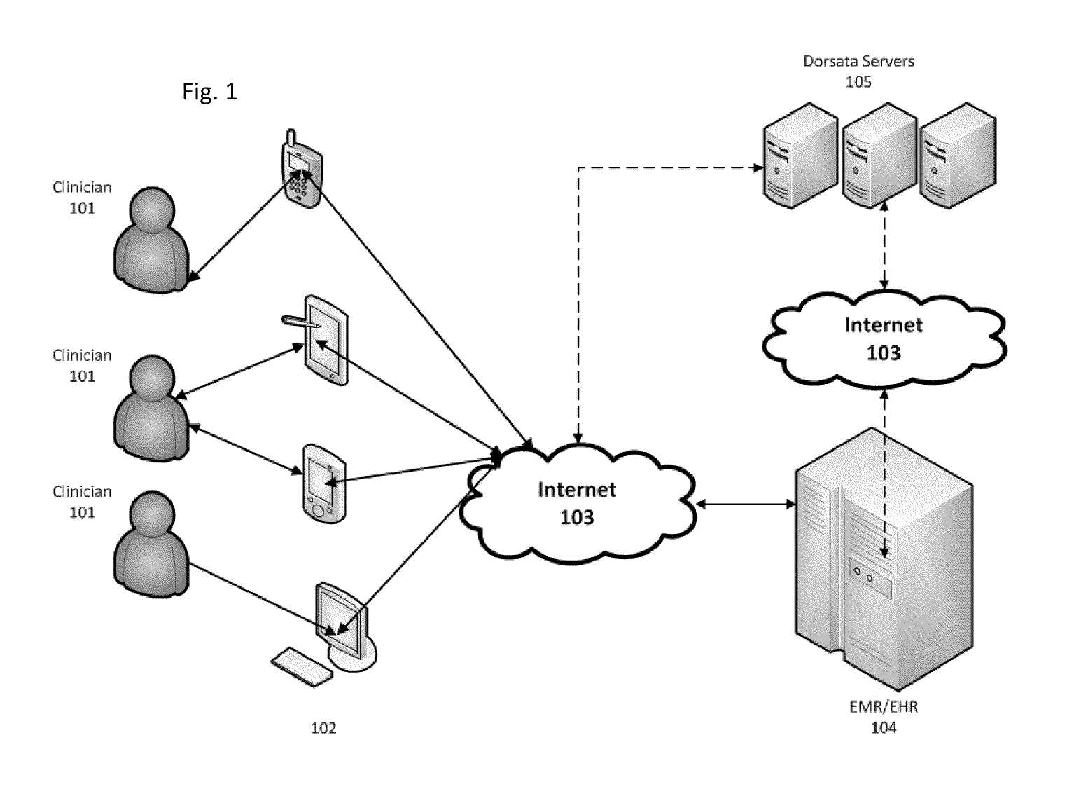

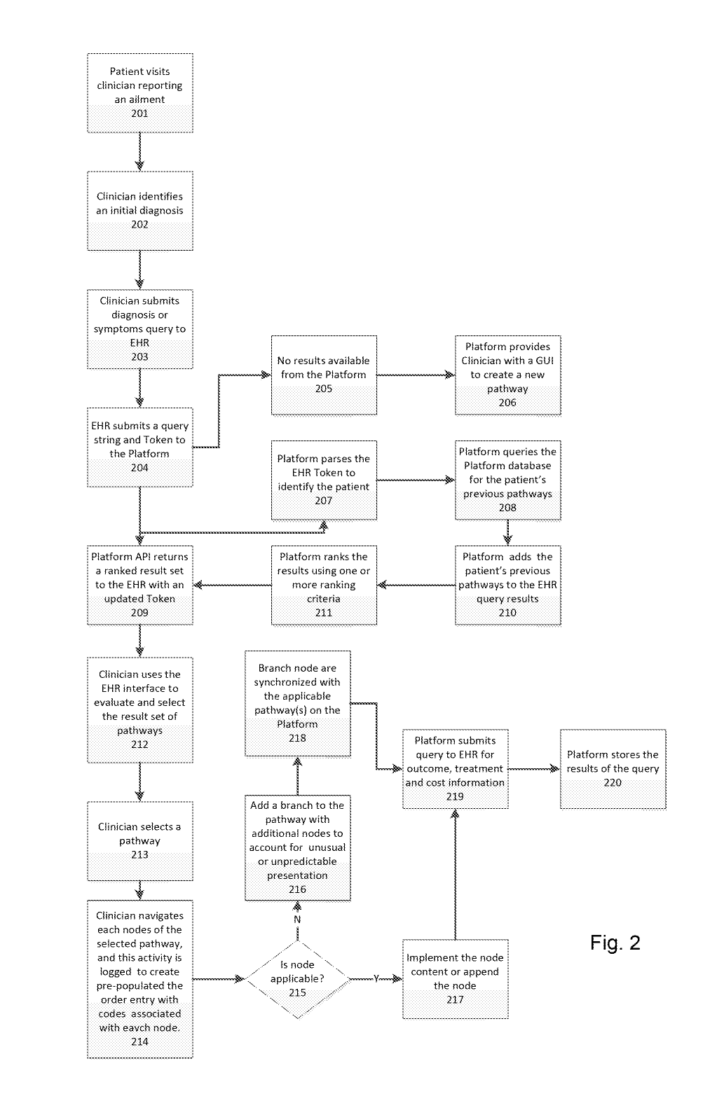

Now referring to FIG. 1, which shows another exemplary implementation of the Platform 105 according to one embodiment. In this exemplary implementation, one or more clinicians 101 may use computers 102 to access an EHR 104 through the Internet 103 during a patient encounter to complete their order sets. The EHR 104 may query the Platform 105 to locate existing pathways related to the patient's diagnosis; to update existing pathways if the patient presents with unusual or unpredictable symptoms; or to create a new pathway based on the patient encounter. FIG. 2 illustrates this implementation in more detail.

As shown in FIG. 2, in step 201, a clinician 101 may undertake a patient encounter. A patient encounter may refer to all cases where a clinician 101 and a patient have an actual physical encounter in which the Clinician renders any service to the patient. A patient encounter may also include a patient seen through telemedicine by a Clinician. A patient encounter may also be present where a clinician 101 and a patient do not have an actual physical or telemedicine encounter, but the clinician 101 may render a minimal consultative service for the patient (e.g. reading an EKG).

During the patient encounter, the clinician 101 may also form one or more initial diagnosis of the patient based on the symptoms present as illustrated in step 202.

In step 203, the clinician 101 may log into an EHR 104 using any conventional means and submit a query about the diagnosis from step 202. The query may include keywords or concepts from the clinician's 101 initial diagnosis in step 202.

In step 204, the EHR 104 may forward the query submitted in step 203 and a token to the Platform 105 using any conventional means. In some alternatives, the query to the Platform 105 may be submitted via an API or web service, such as the REST web services. In some alternatives, the token may be any type of conventional token, with a unique EHR 104 identifier, identifying the EHR 104 of a patient and a unique identifier identifying the clinician 101. For example, a user may enter the query “suspected pulmonary embolism” into the EHR 104 interface. The EHR 104 may format an HTTP request, such as a GET request, and may send that request to the Platform. In addition to the query string, the EHR 104 may also include a number of other parameters in the HTTP request such as a user authentication token, which may uniquely identify the user of the Platform 105 that may be submitting the query (as described below) or other details such as medical specialty area, desired networks such as institution, or other users.

In step 205, if the Platform 105 is not able to locate a pathway for the submitted query from step 204, the Platform 105 will send the clinician 101 a notification through the EHR 104 with a URL to create a new pathway on the Platform 105 as illustrated in step 206 and described below.

In step 207, the Platform 105 may parse the token from step 204 using any conventional means. The Platform 105 may extract the unique EHR 104 identifier for the patient and may generate a query string to query the platform for the patient's previous pathways as illustrated in step 208. In some alternatives, the Platform 105 may append the unique EHR 104 identifier for the patient to the query submitted in step 204. In some alternatives, the Platform 105 may submit the unique EHR 104 identifier for the patient as a separate query from the query received in step 204.

In step 209, the Platform 105 may execute the queries submitted in steps 204 and 207 and aggregates the result set into a single result set. In some alternatives, the Platform 105 may provide two separate result sets for the queries submitted in steps 204 and 207. In some alternatives, the result set may be a list of clinical pathway results in the Platform 105 that may have met the query parameters in steps 204 and 207.

In step 210, the Platform 105 may rank the result sets using any of the ranking criteria described below and may update the token from step 204 with a unique identifier for the ranked result set. In some alternatives, the unique identifier may be a randomly generated string by the Platform. In some alternatives, the unique identifier may identify the clinician's 101 location. In some alternatives, the unique identifier for the clinician 101, specific data from the patient outcome, number of pathways delivered to the EHR 104, pathway(s) selected from the list by the clinician 101, or whether the clinician requeried the Platform 105 and selected another pathway from the new result set.

In step 211, the Platform 105 may return the ranked result sets to the EHR 104 via any conventional means, such as an API or web service. In some alternatives, the result sets may contain a single pathway as illustrated in Appendix B. In some alternatives, the result sets may contain multiple clinical pathways as illustrated in Appendix A. In some alternatives, the API may be the REST API. In some alternatives, the Platform 105 may return the data to the EHR 104 via another HTTP request, such as a POST request, in JSON, XML, or similar formats. These formats may provide structured, well-documented “key/value” pairs that can be consumed by any computer system. In step 212, the clinician 101 may evaluate and review the result set from the Platform. In some alternatives, the result sets may contain dynamic clinical pathways described below. In some alternatives, the result set may be displayed within the EHR's 104 GUI. In some alternatives, the result set may be displayed outside of the EHR's GUI.

In step 213, the clinician 101 may select one or more pathways in the result set and navigate the pathway as described below. Upon selecting the appropriate pathway, the EHR 104 may send another HTTP request to the Platform 105 to request the pathway's content as illustrated in Appendices A and B. The Platform 105m may use the HTTP request, such as a GET request, to query the Platform's server for all pathway content, including, but not limited to, pathway nodes, supplemental content, cited evidence, published articles, comments, and mapped medical terminology and codes. The Platform 105 may format the pathway data in JSON, XML, or similar formats, then send the information back to the requesting EHR 104 via an HTTP request such as a POST request. In some alternatives, the Platform 105 may audit or log the pathway selected by the clinician 101. In some alternatives, the Platform 105 may audit or log all of a clinician's activities for each node accessed in a selected pathway. For example, the Platform 105 may create a record that may associate the various unique identifiers outlined above (e.g. clinician, encounter/patient etc.) with a specific node. The Platform 105 may keep a chronological log of each node that is accessed by the user. If a node is accessed through the EHR 104 interface, the EHR 104 may send an HTTP request to the Platform 105, triggered by the clinician's 101 selection of a specific node, along with the unique identifiers so that the Platform 105 can track how the clinician may be navigating the pathway.

In step 214, the Platform 105 may generate an order set based on the clinician's 101 navigation of nodes in the pathway as described below. In some alternatives, the EHR 104 may then leverage the underlying pathway content, specifically the mapped medical terminology and codes, to deliver an order entry experience. This experience may direct the user through his data entry process by using pathway nodes as a step-by-step ordering mechanism. The underlying medical terminology and codes returned by the Platform's server may be filed in the EHR 104. In some alternatives, the interface may be used to automate the input of data from the EHR 104 to the Platform. In some alternatives, a user may submit additional parameters in his query to the Platform, through the EHR's 104 HTTP request, based on data from an EHR 104 related to a patient encounter, such as demographics, past medical history, medications, lab results or other data. The Platform 105 may provide results, in a similar manner as described above, that may suggest one or more appropriate clinical pathways which are appropriate for management, ideally personalized based on a provider's institution, specialty, prior usage, known patient preferences, etc. The pathways provided to the user, via the EHR 104, by the Platform 105 may then be used to facilitate the aggregation of medical codes, which would be filed in relation to the specific patient encounter.

In step 215, during navigation of the pathway if the patient presents unusual, unpredictable or unexpected symptoms, as illustrated in step 216, the Platform 105 may provide the clinician 101 with a GUI to add a branch to the selected pathway. In some alternatives, the branch may contain one or more nodes addressing the unusual, unpredictable or unexpected symptoms. In some alternatives, the branched pathway may be stored as a new non-published version of the selected pathway. In some alternatives, the contributors or users who collaborated on the pathways, as discussed below may receive a notification about the new non-published version of the pathway. If the EHR 104 provides an interface for branching the selected pathway as discussed above, then as illustrated in step 218, the nodes of the branch and/or update pathway may be synchronized with the Platform. The Platform 105 will store the updated pathway as a new-non published version of the selected pathway. In some alternatives, as a result of this update, the Platform 105 may update the shapes and colors of the nodes as discussed below.

In step 217, if the patient does not present any unusual, unpredictable or unexpected symptoms, during the patient encounter, then the clinician 101 may implement the node, which appends the order set for the patient.

In step 219, at a predetermined time or at the occurrence of a specified event, the Platform 105 may query the EHR 104 for information, such as outcome, treatment, costs associated with the patient encounter. The Platform 105 may store this information as illustrated in step 220.

In some alternatives, the Platform 105 may provide supporting content and references/articles to a clinician at the point of care, i.e., through the structured JavaScript Object Notation (“JSON”) object, received from the third-party application. Clinicians 101 may be able to reference appropriate supplemental content as part of the decision making process. For example, the Platform 105 could provide the abstract of a particular article or publication for viewing directly in the EHR, which may support the clinician's 101 decision.

In some alternatives, as discussed above, the Platform 105 may allow for the real-time customization and usage of pathways for order-entry inside of a third party application such as the EHR. For example, the clinician 101 may desire to alter the pathway they are currently using. The clinician 101 may make modifications to the clinical pathway in the EHR 104 and the modification may be synchronized with the Platform 105 as discussed above. The new pathway content may also be used for order entry. Should a clinician decide to go off a pathway inside of the EHR 104, the Platform 105 may accept the new content and create a new branch in the pathway automatically. For example, a clinician 101 may encounter a branch in a pathway that may not have an appropriate answer for an unexplained or unusual symptom. The clinician 101 may have to create a new branch to the pathway on the fly, find the applicable medical terminology/codes inside of the EHR 104, and may then enter them in the patient's record. The Platform 105 may provide a benefit by indication how the clinician's decisions may have differed from the pathway and perhaps may support a new branch of a pathway.

The platform may learn how clinicians are making their decisions by tracking the various paths taken through the pathway. In other words, the platform may be able to understand trends in the decision-making process and eventually over time provide insights to the subjective clinical decision making process and how it drives the underlying EHR 104 data.

The platform may be utilized to overlay a particular patient's data/triage/care on top of a pathway. For example, a patient may have been placed on a suspected pulmonary embolism pathway. The clinicians 101 could see, through visual cues, how the patient has progressed through the pathway. Branches/nodes that have been selected for that patient may appear in different colors than others. The platform may provide a mechanism for a third party application to request, receive, and display a full image file of the user-created pathway in multiple conventional formats, such as png, jpg, or other formats. The platform may provide a mechanism through which the dynamic representation of the pathway may be edited. In other words, the platform may be able to deliver pathway content inside of the EHR 104 in a manner similar to its website, through which the user would be able to utilize all of the Platform's 105 content creation features to modify the pathway. This may be accomplished via an iframe embedded inside of the EHR 104. In this manner, the EHR 104 will be displaying a specific Platform 105 GUI view within the EHR's 104 interface. This view may be delivered by the Platform. The platform may provide a mechanism for comparing specific medical terminology/codes across various databases such as SNOMED, CPT and ICD. In this manner, a clinician 101 using an EHR 104 or other health system database may be able to consume and utilize a pathway that has been coded in a different coding database. The Platform 105 may accomplish this by making specific requests to the Unified Medical Language Service (“UMLS”) through which a specific code may be sent and the set of related codes may be received.

Creating a Pathway

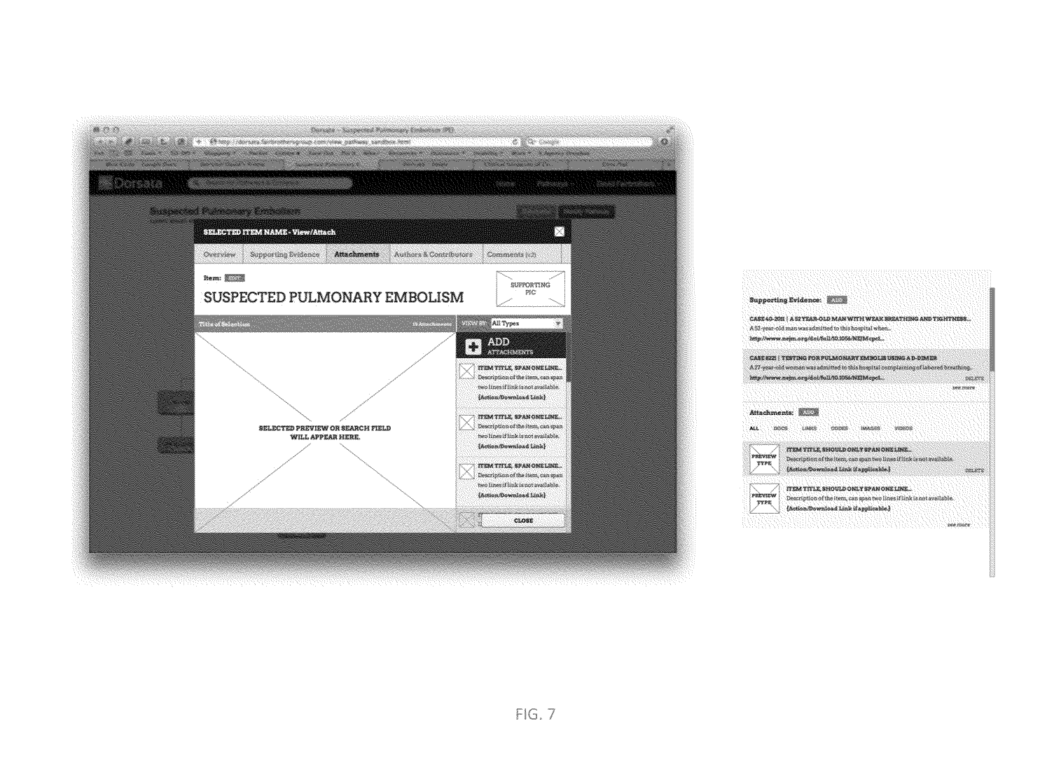

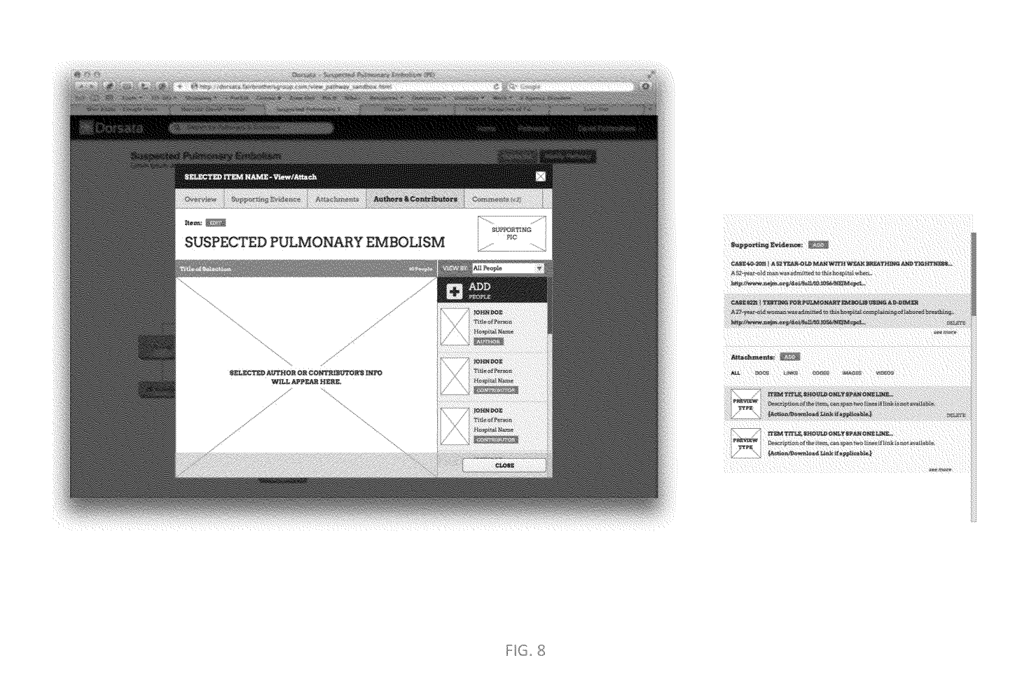

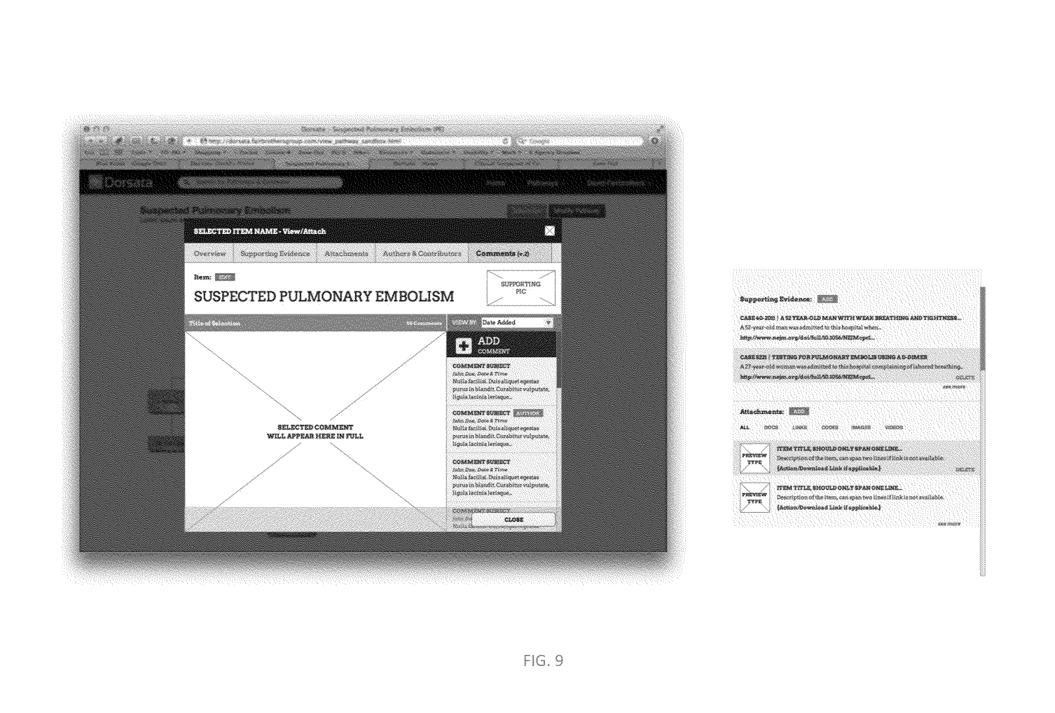

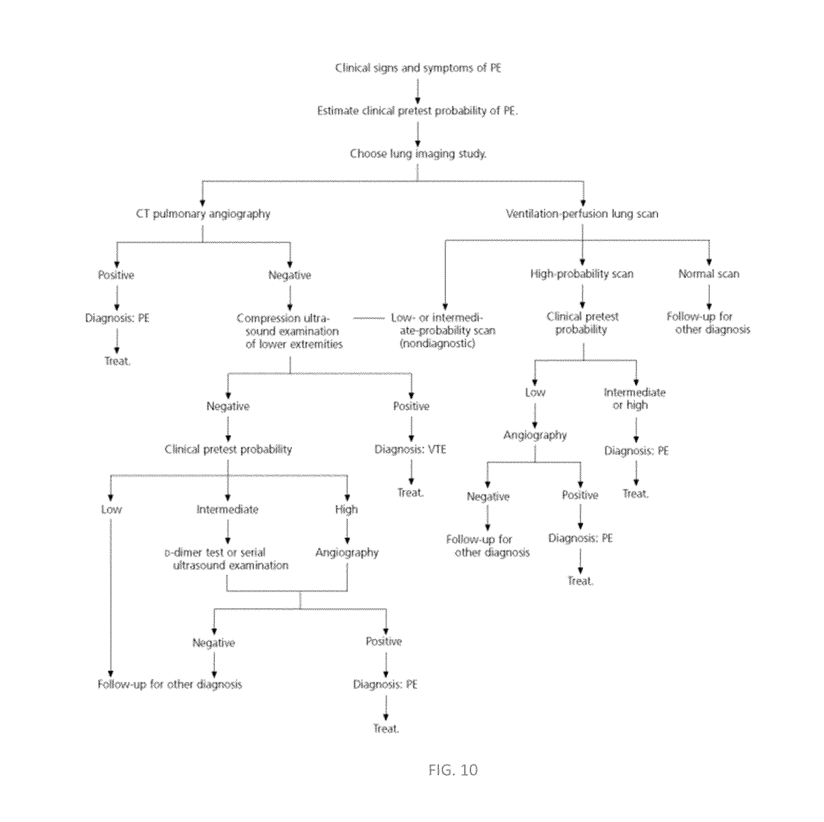

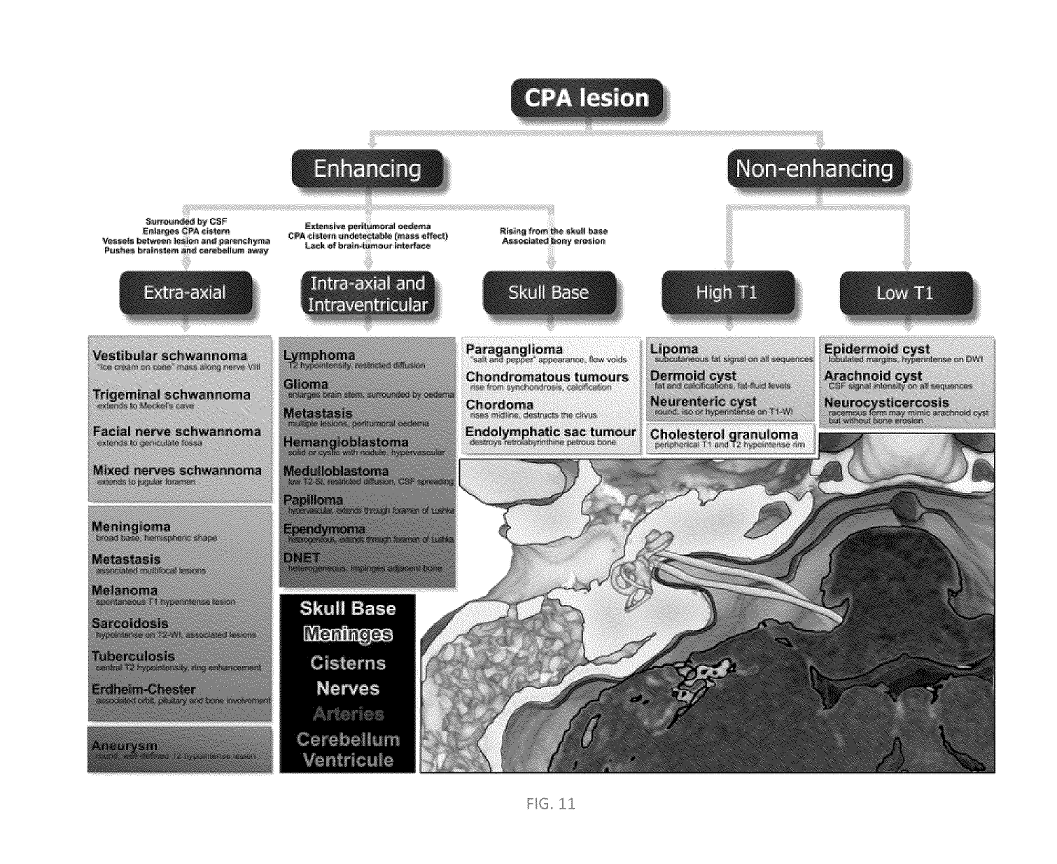

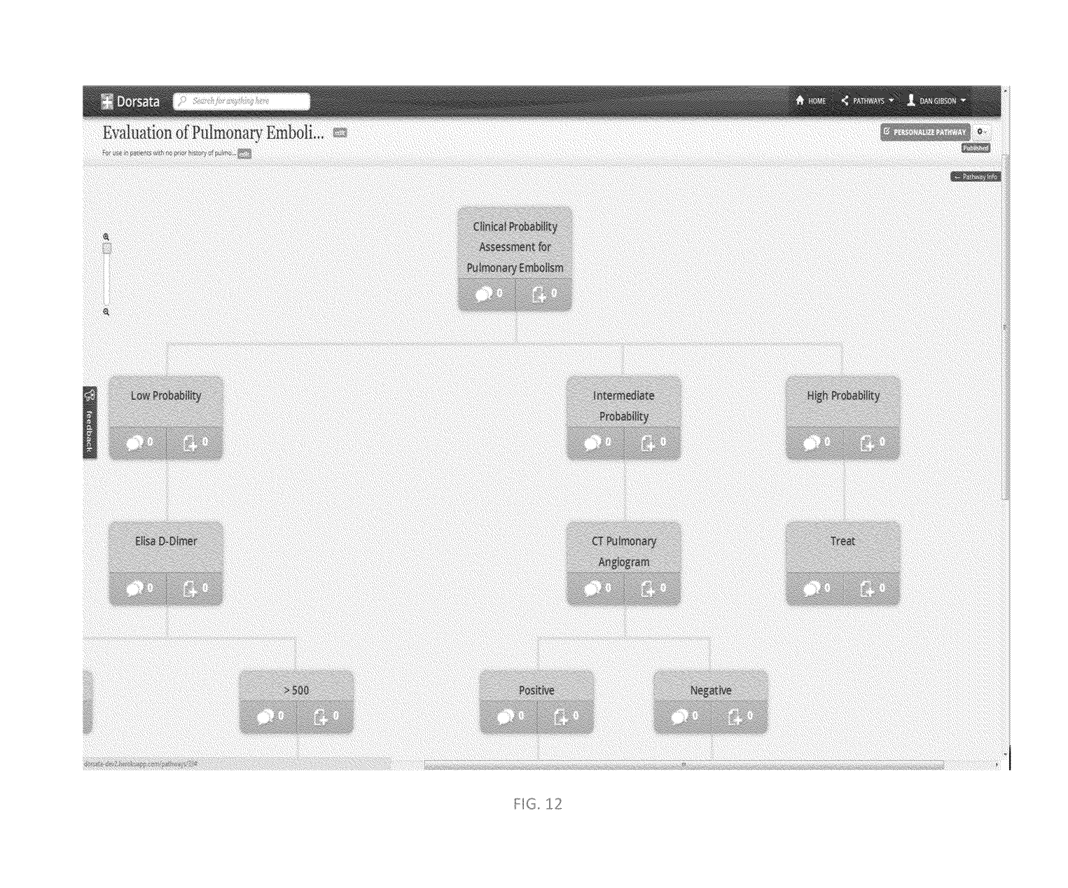

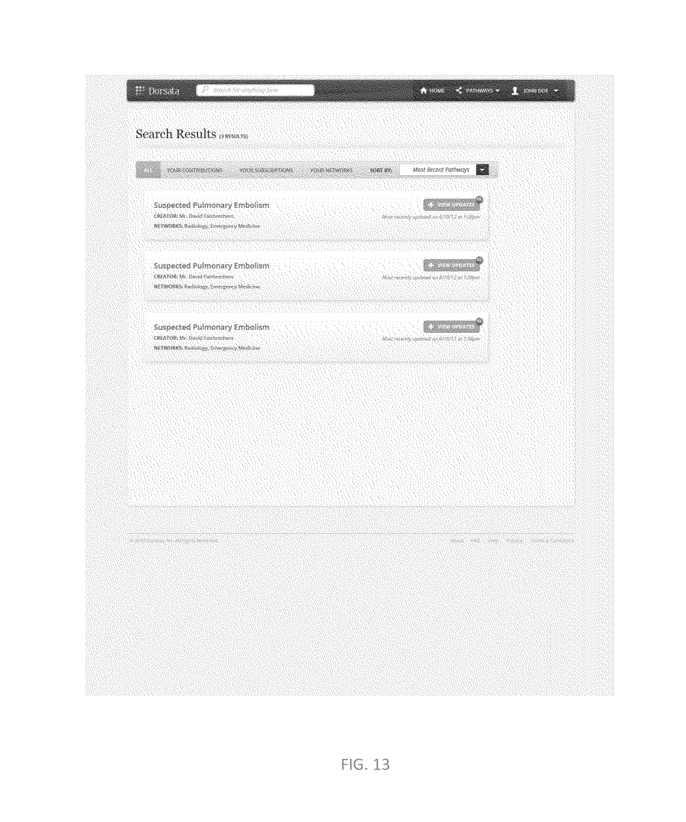

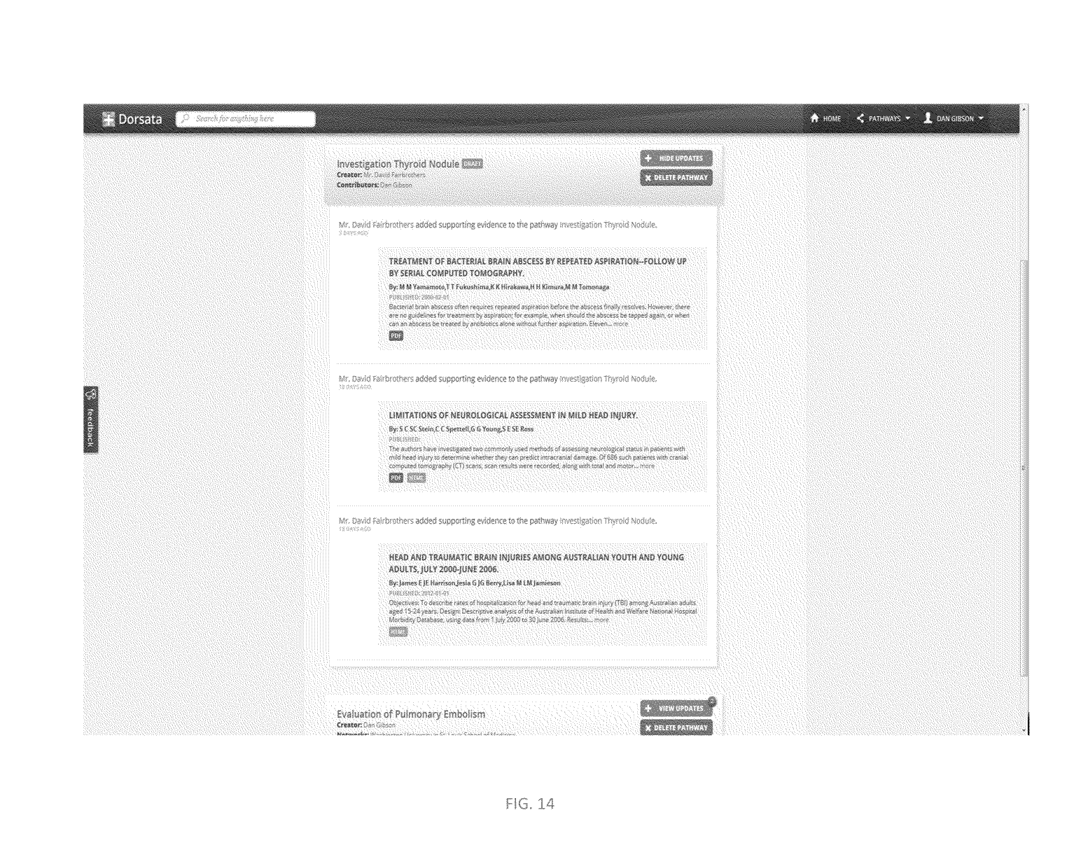

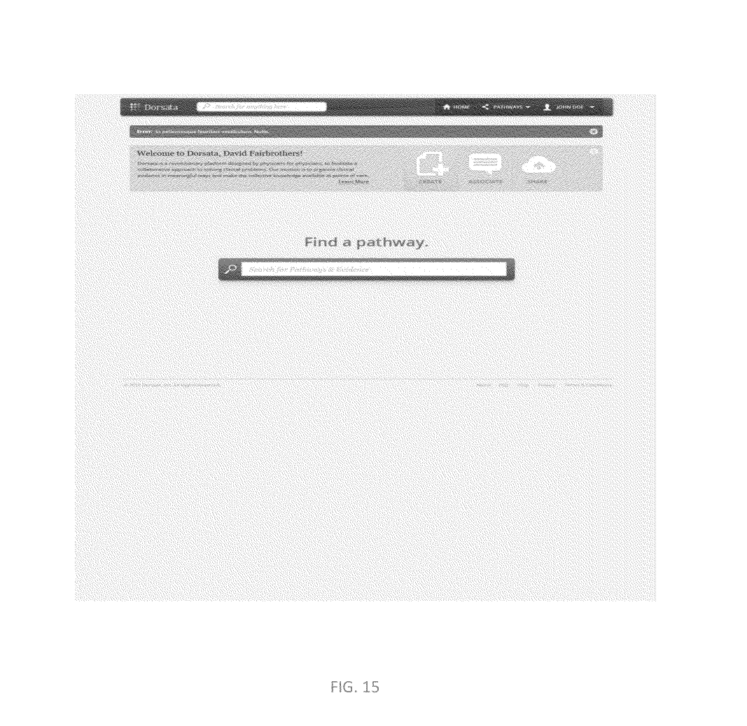

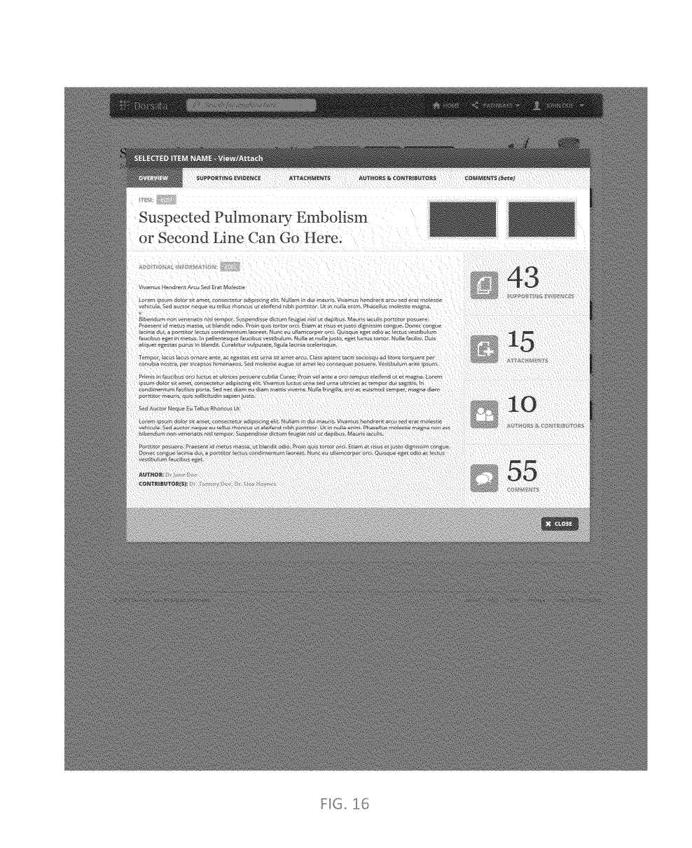

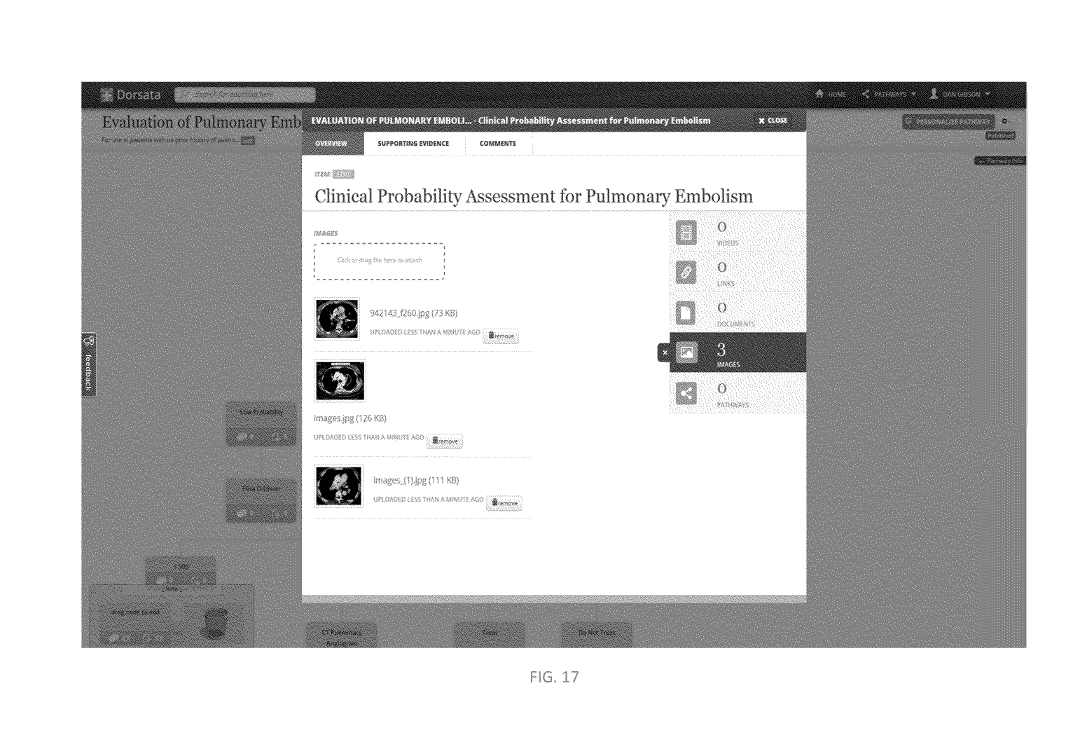

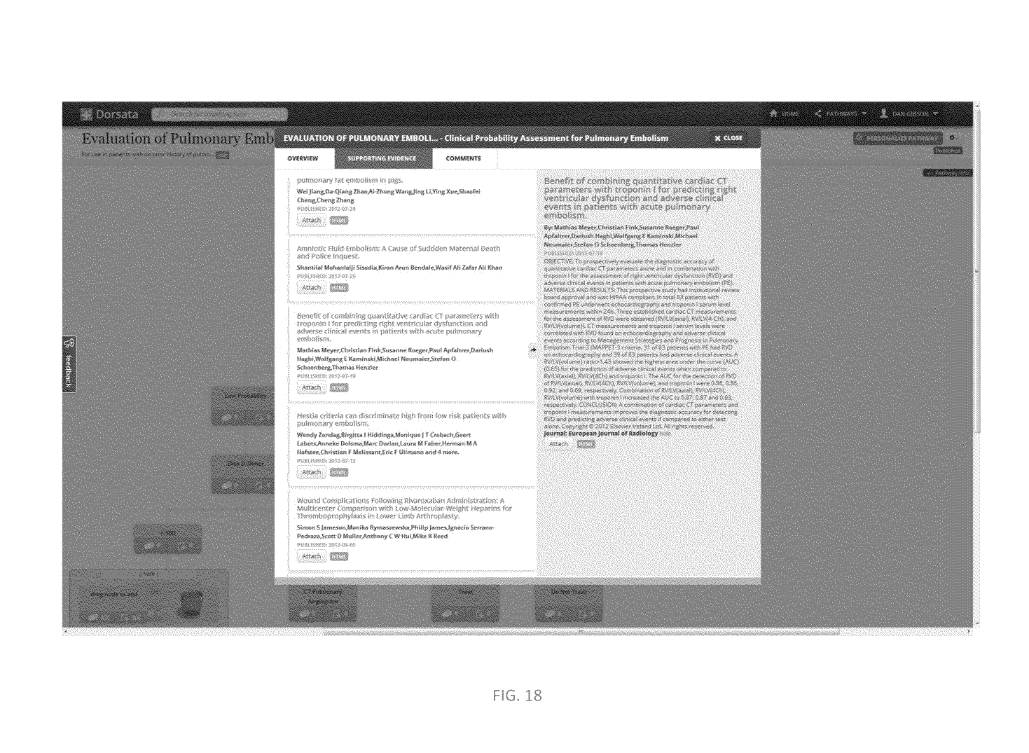

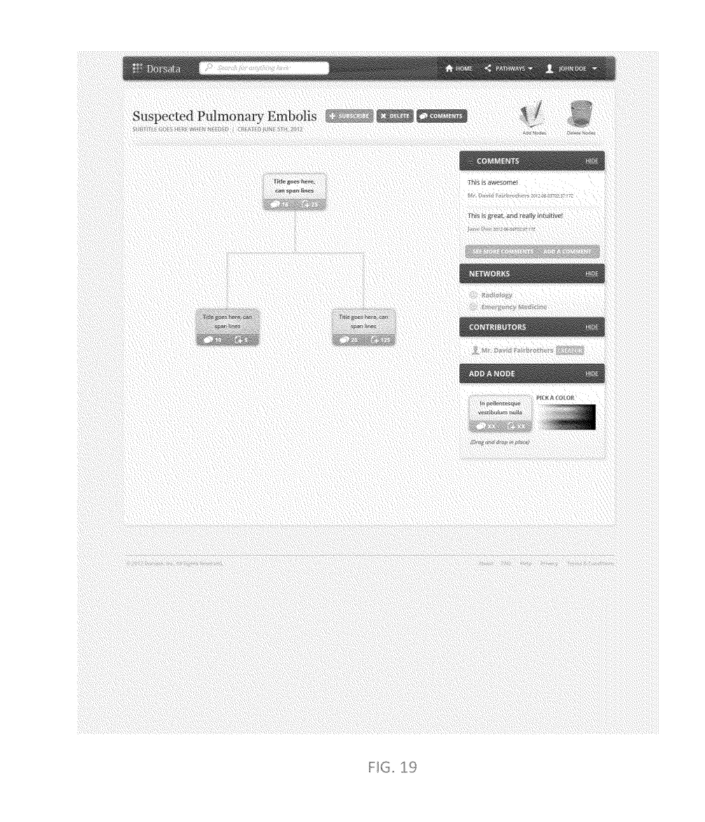

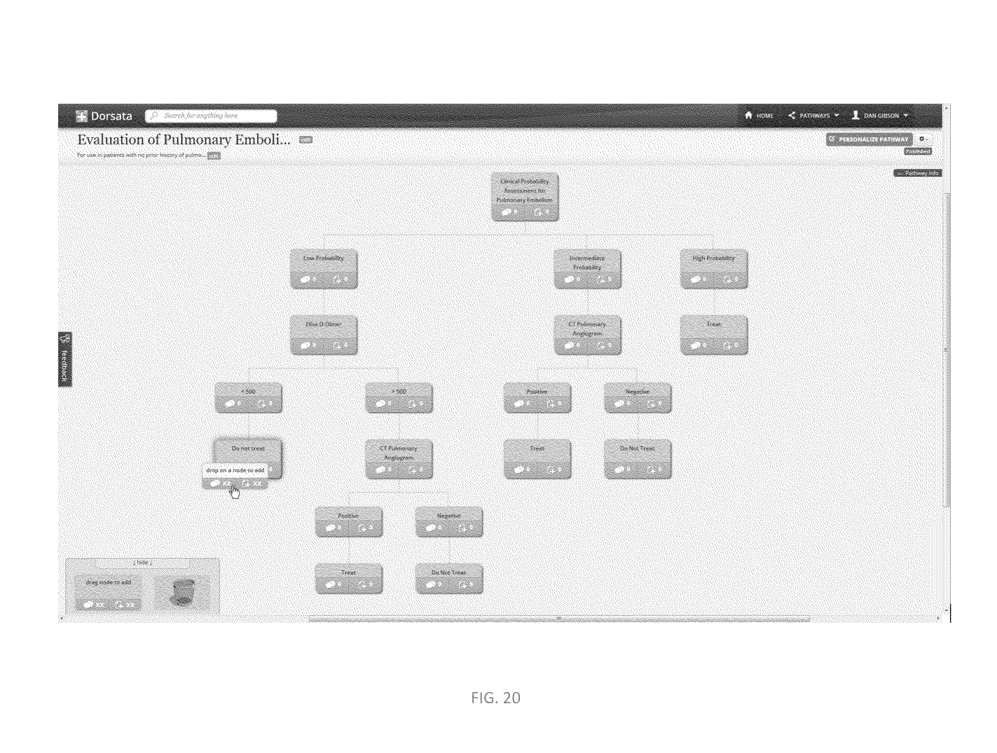

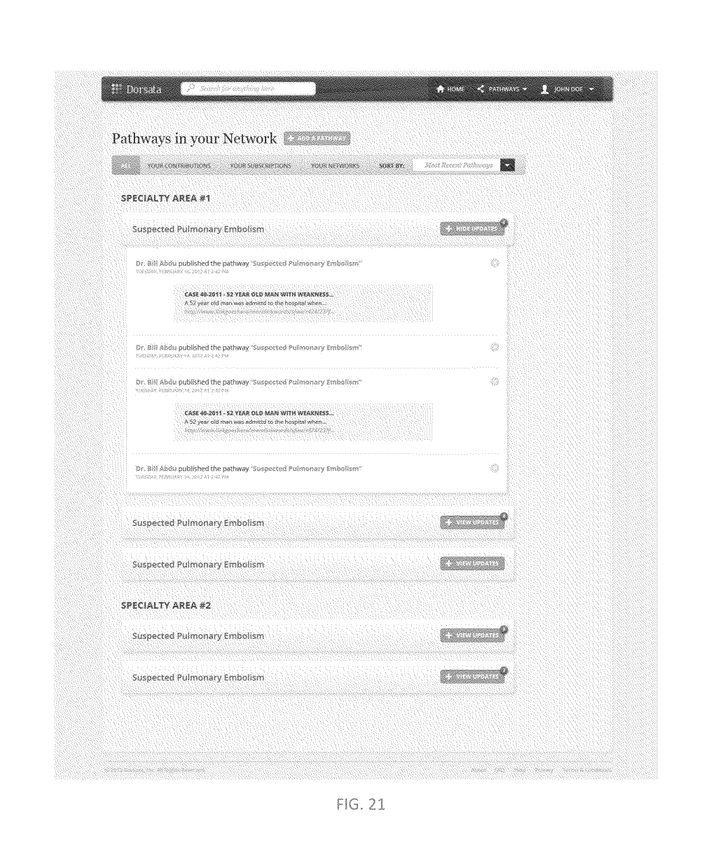

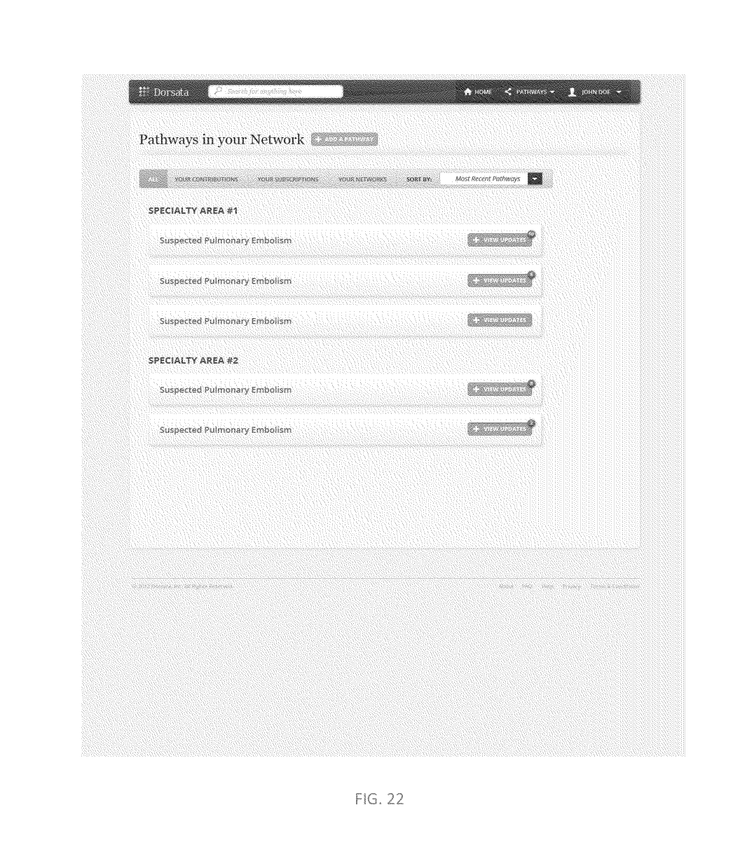

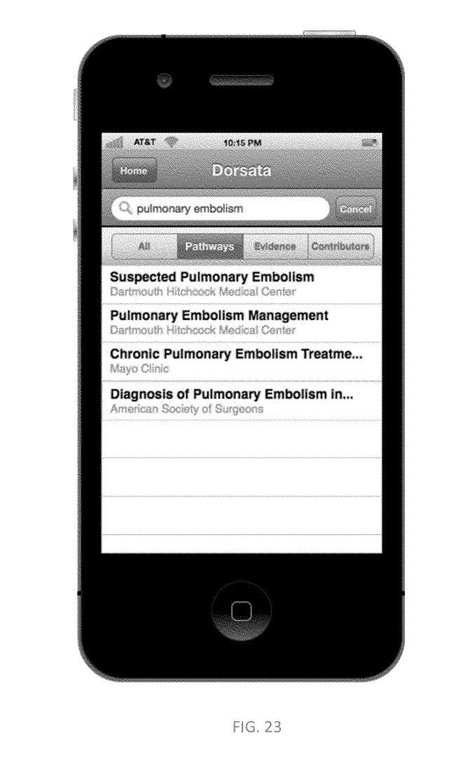

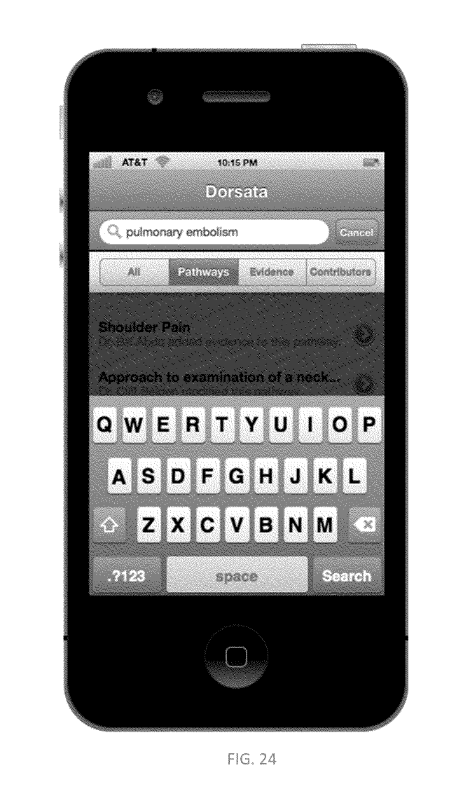

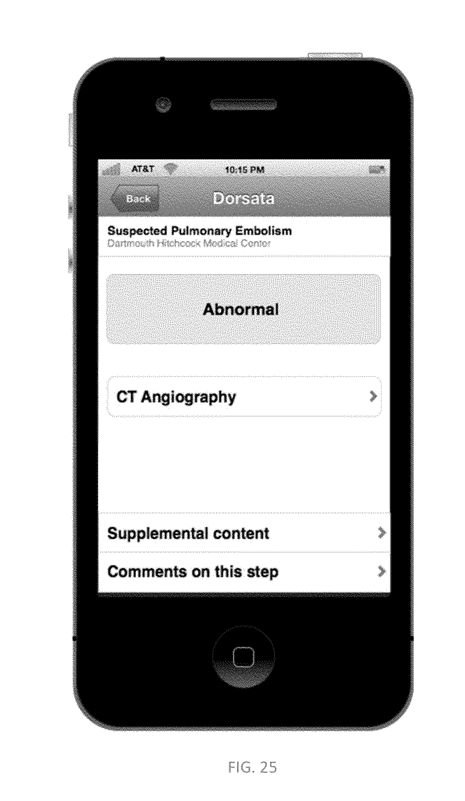

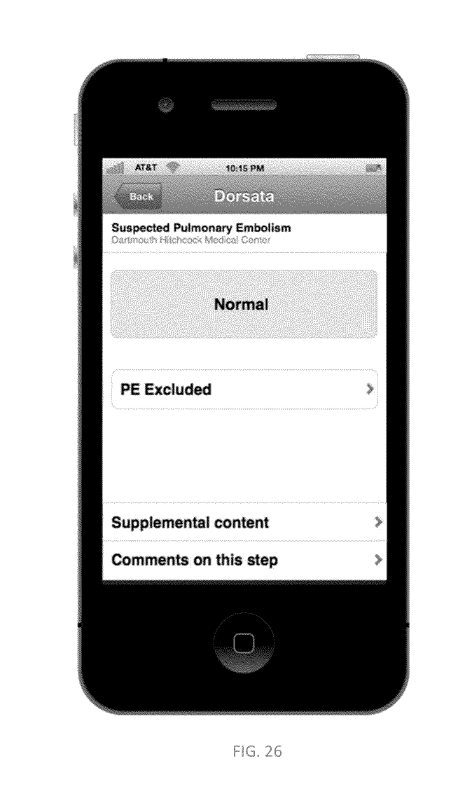

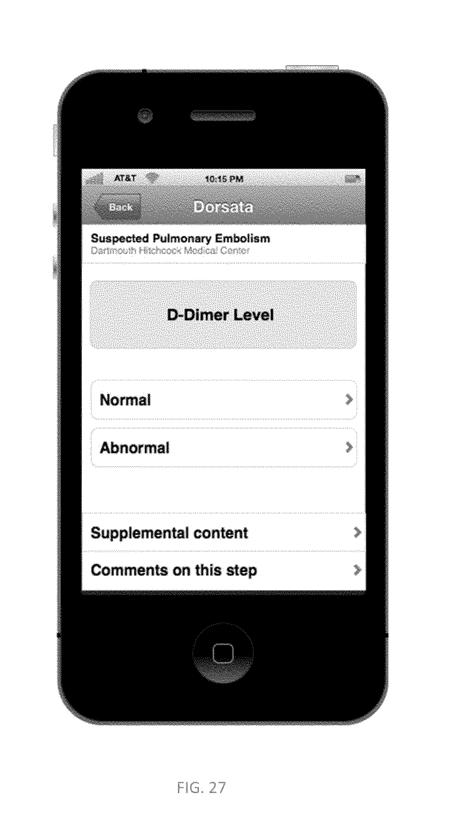

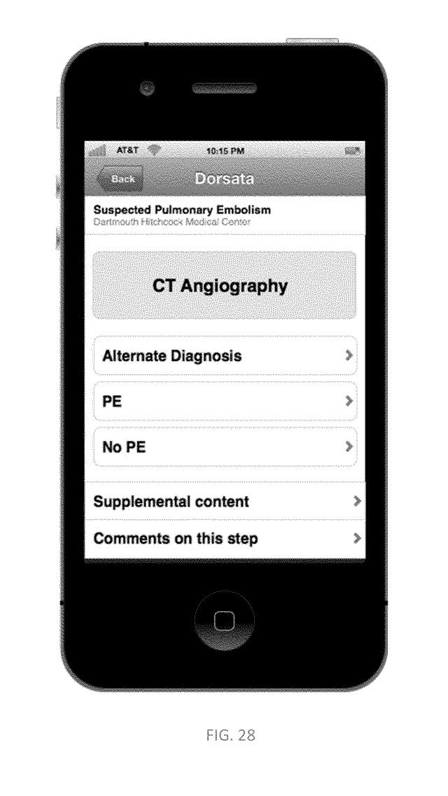

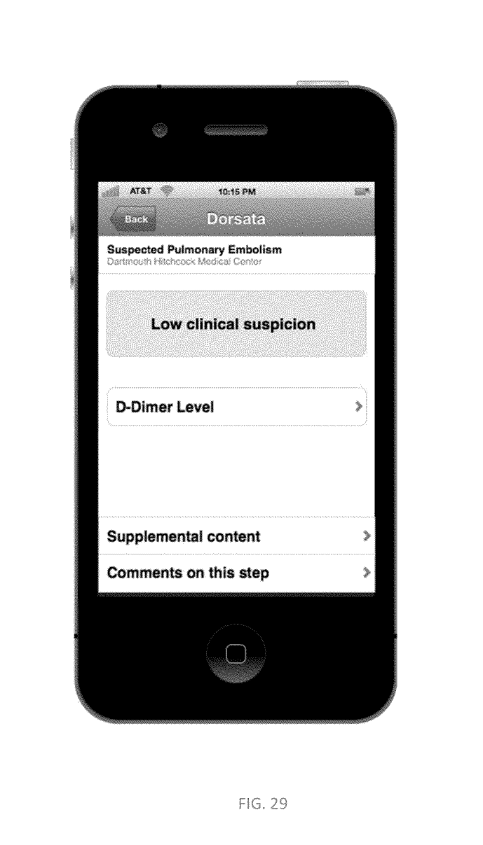

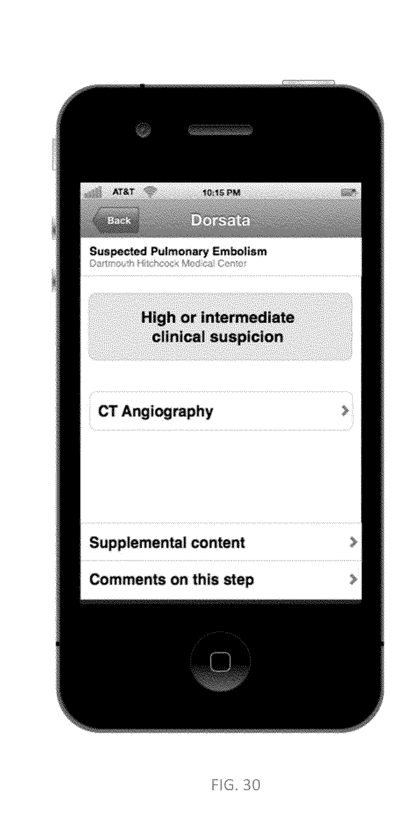

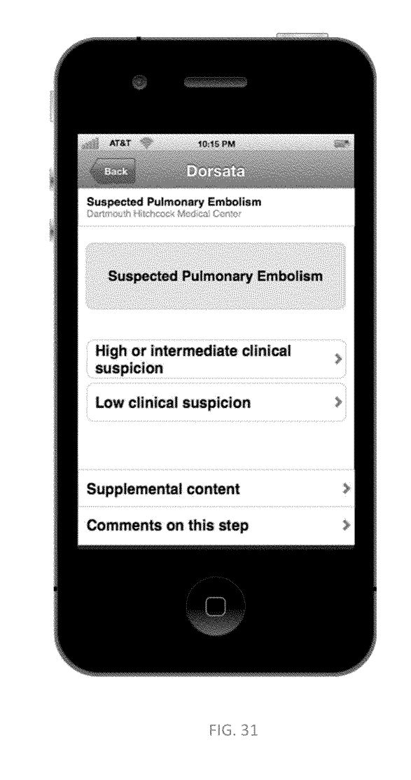

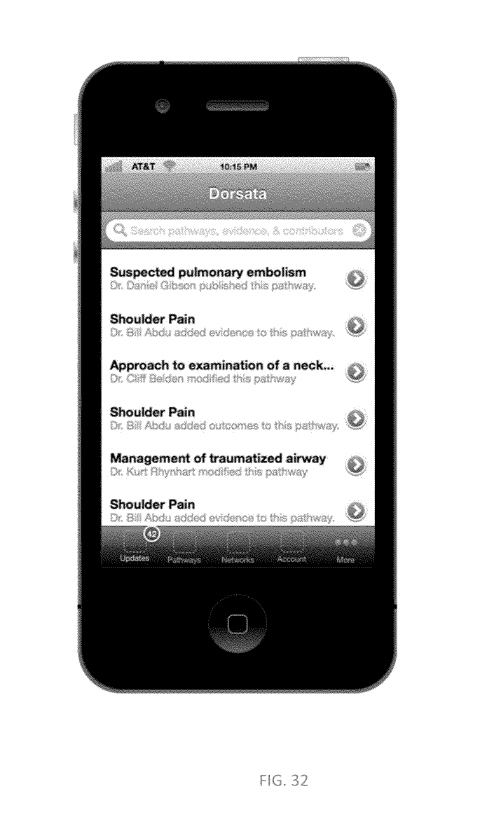

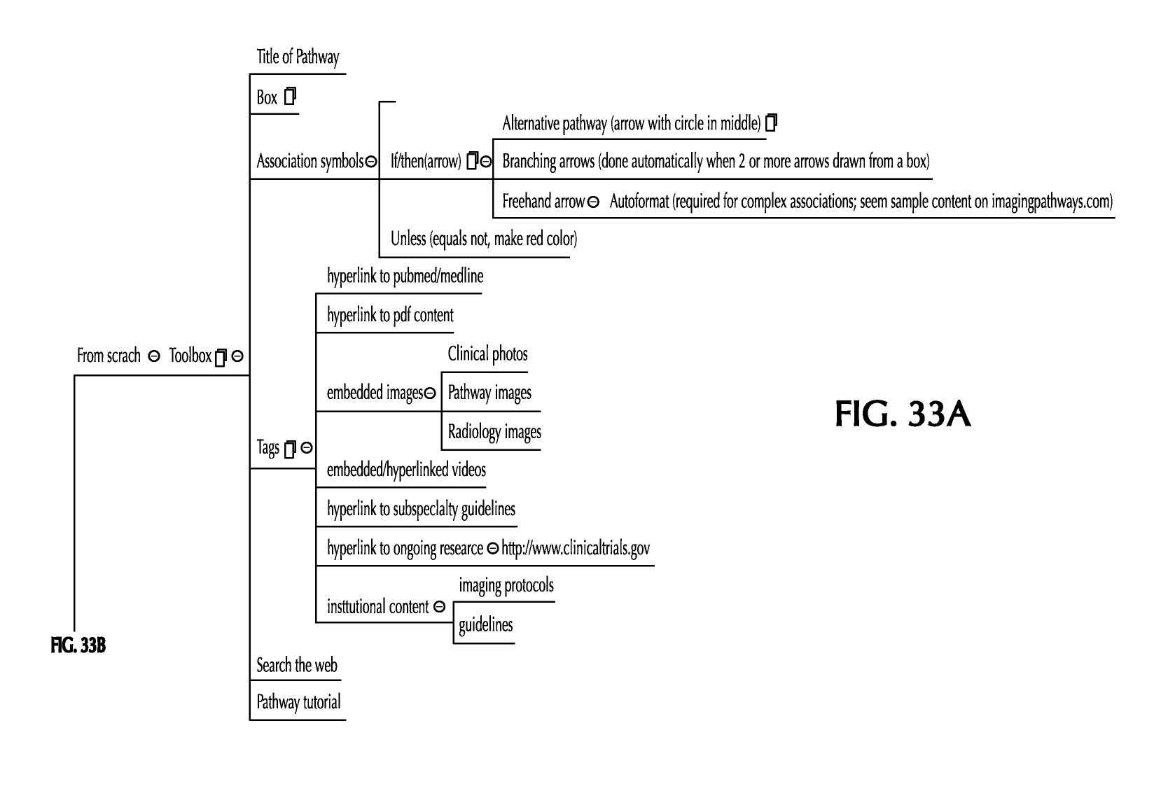

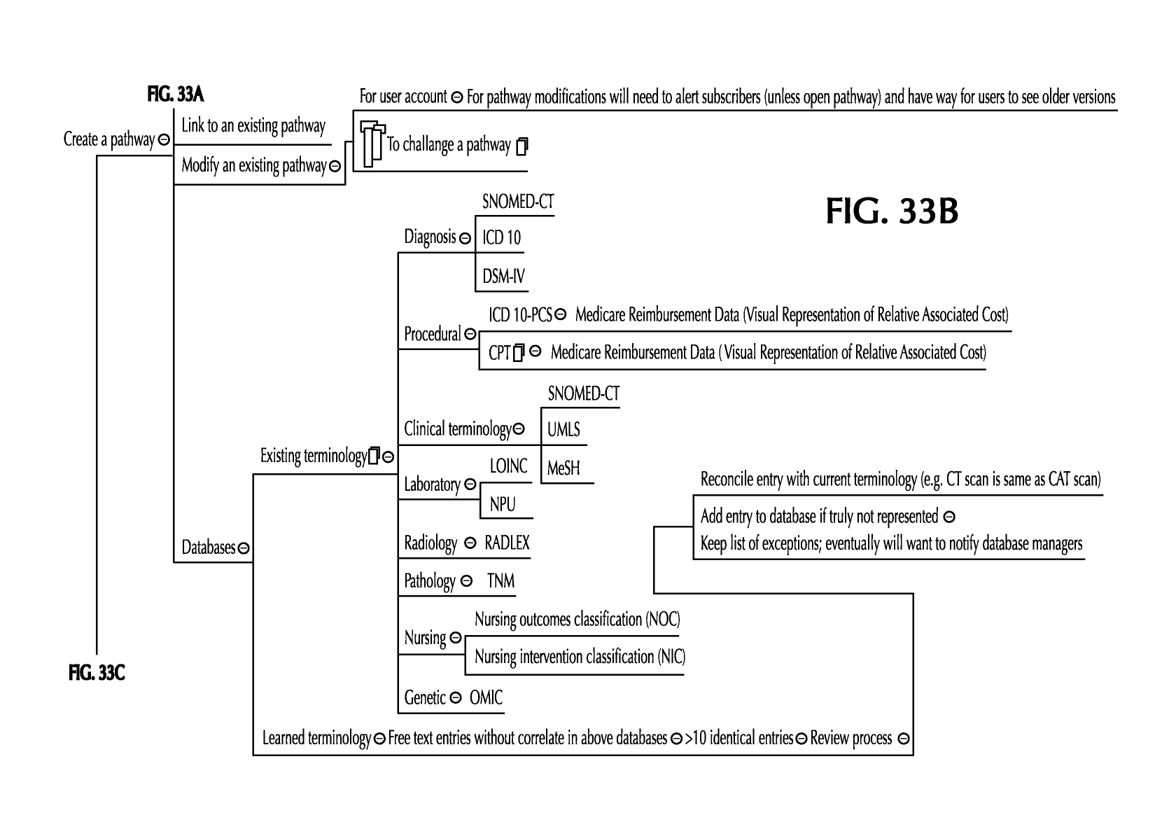

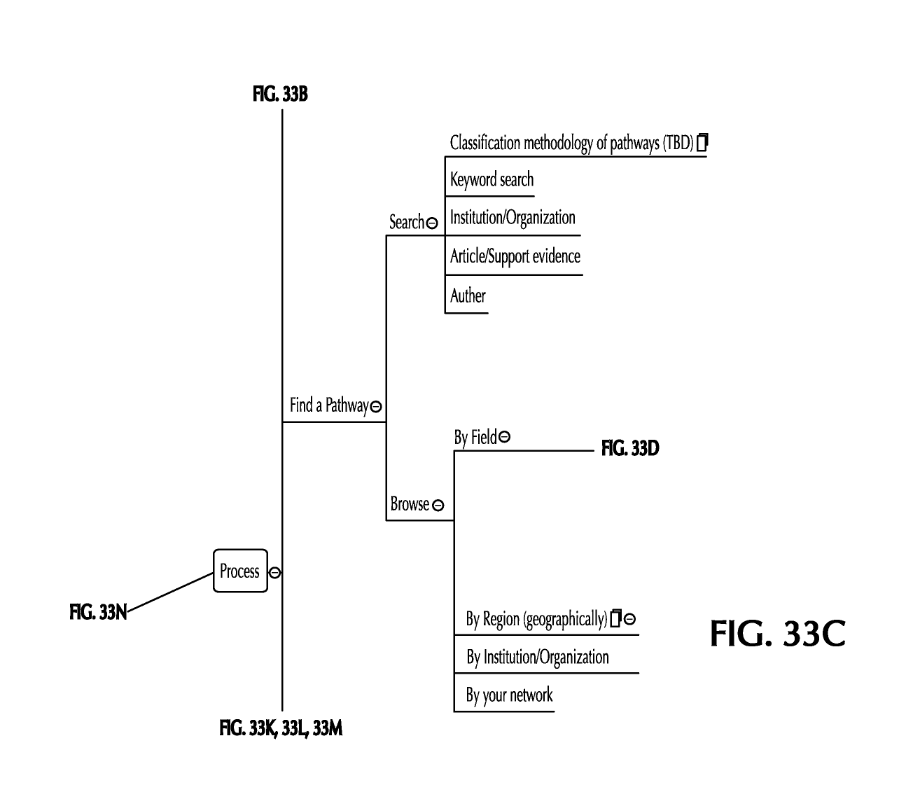

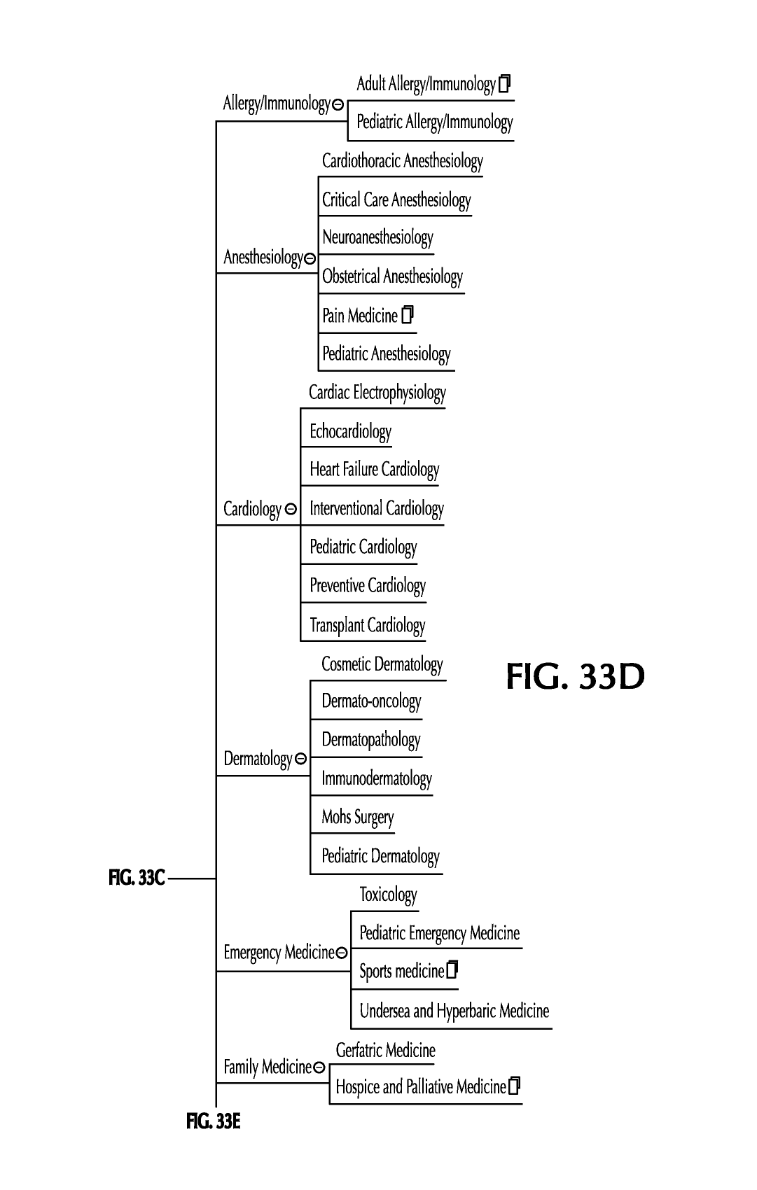

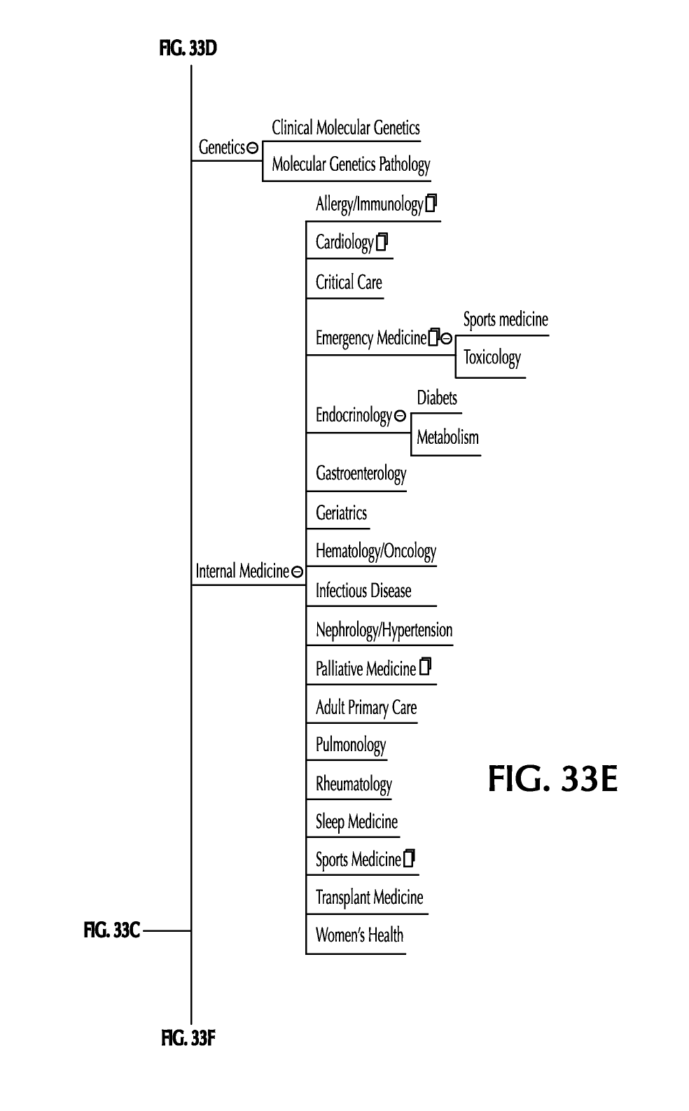

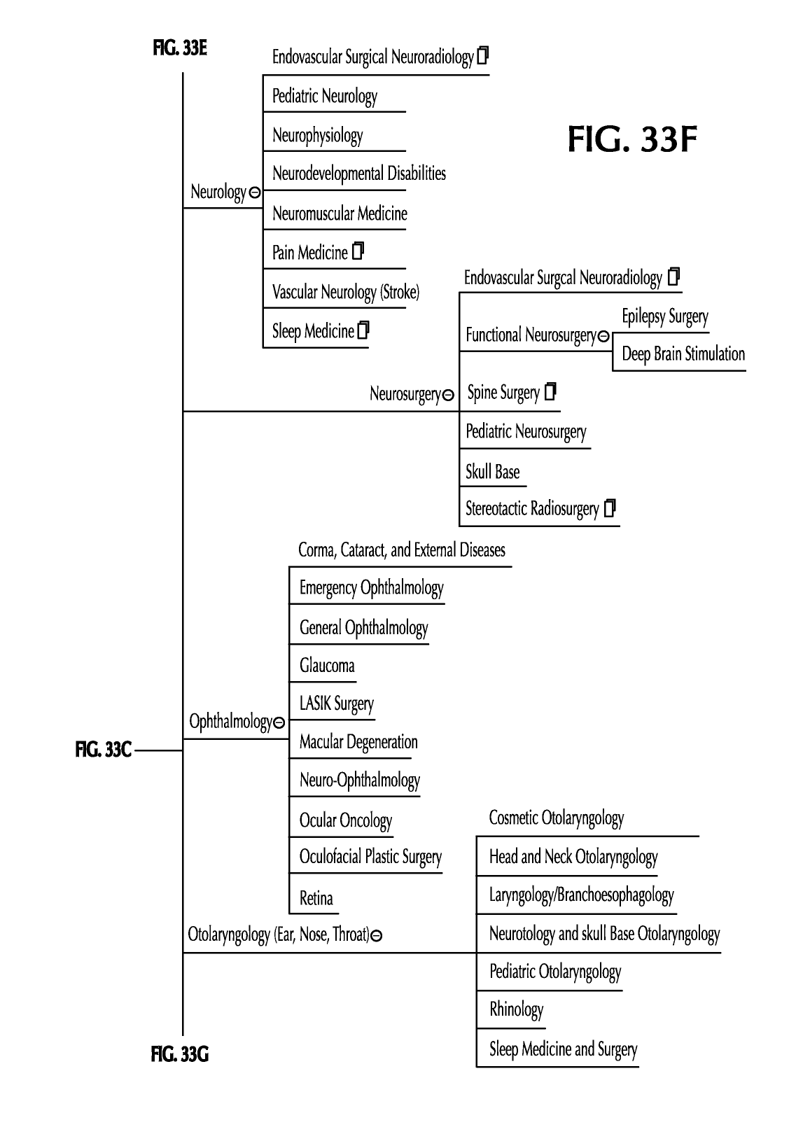

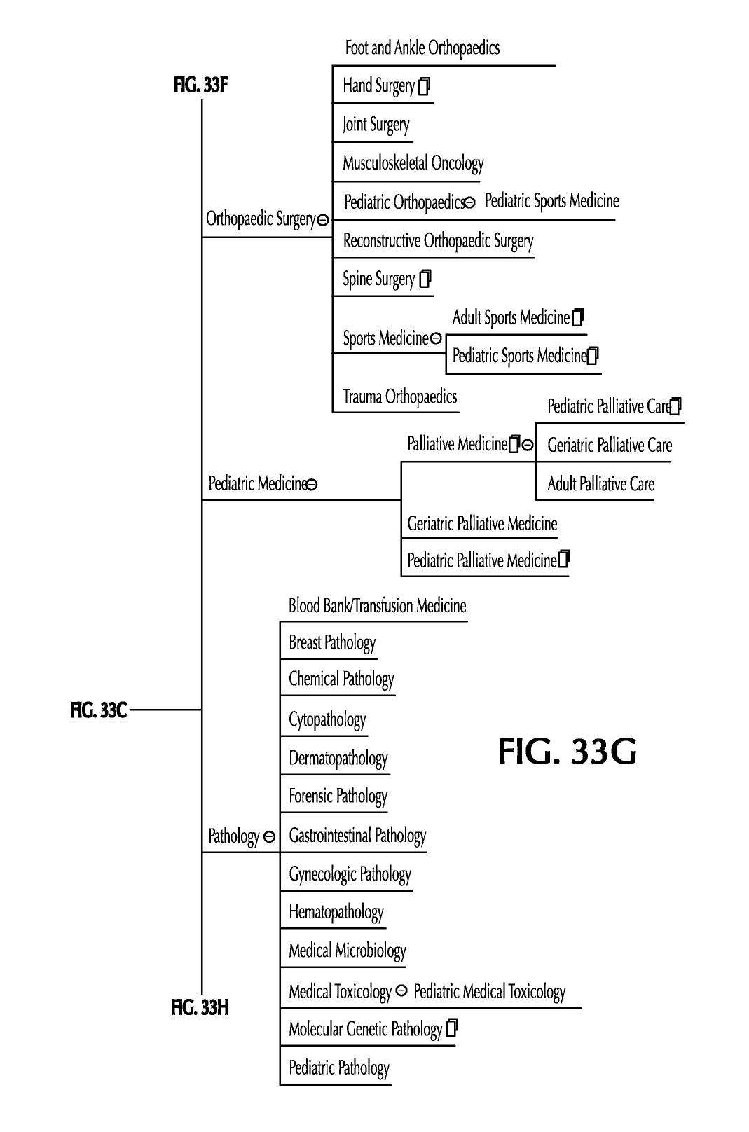

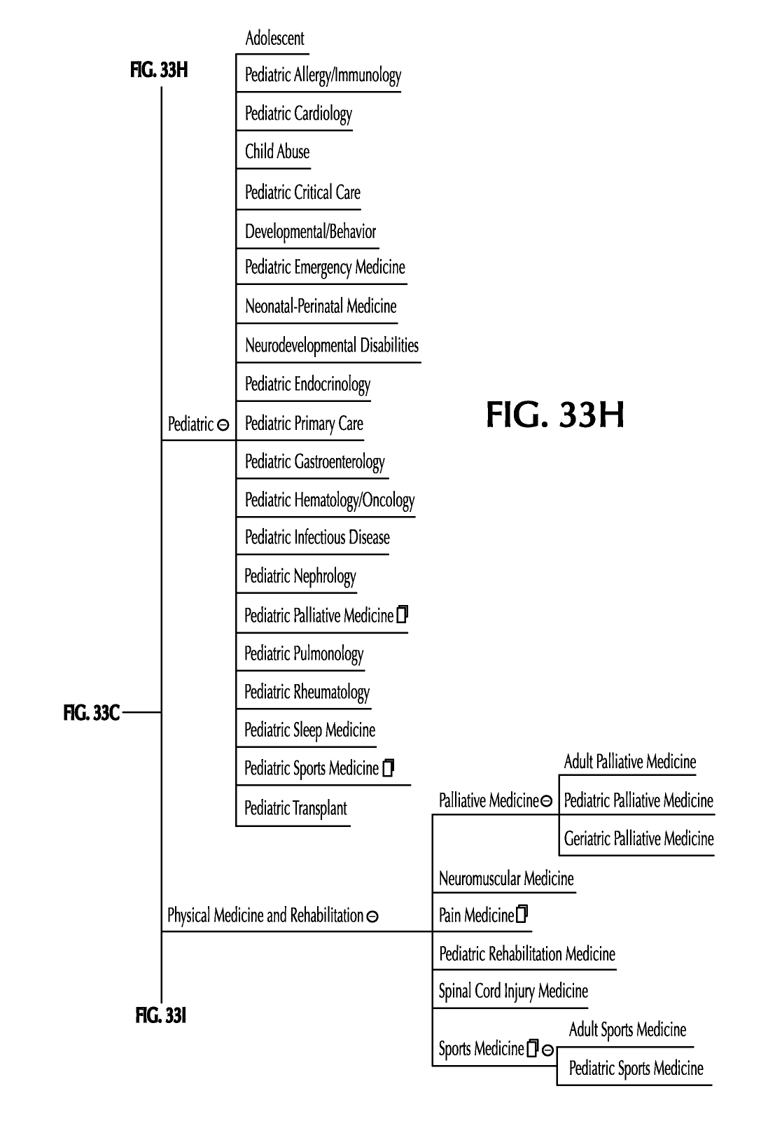

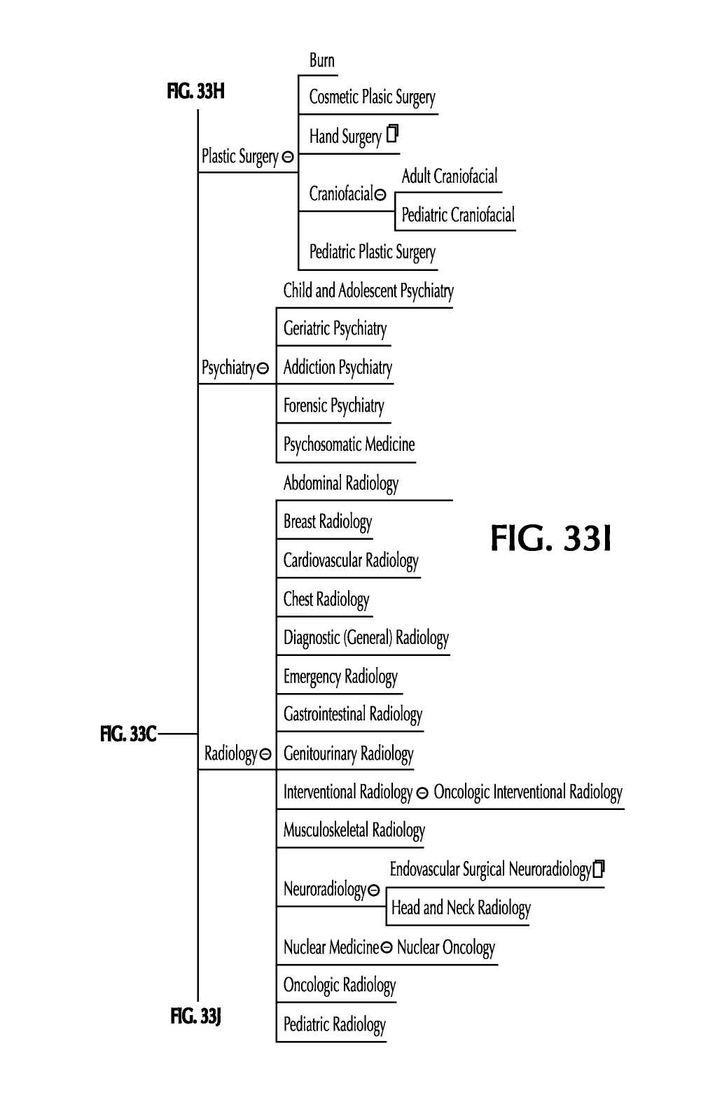

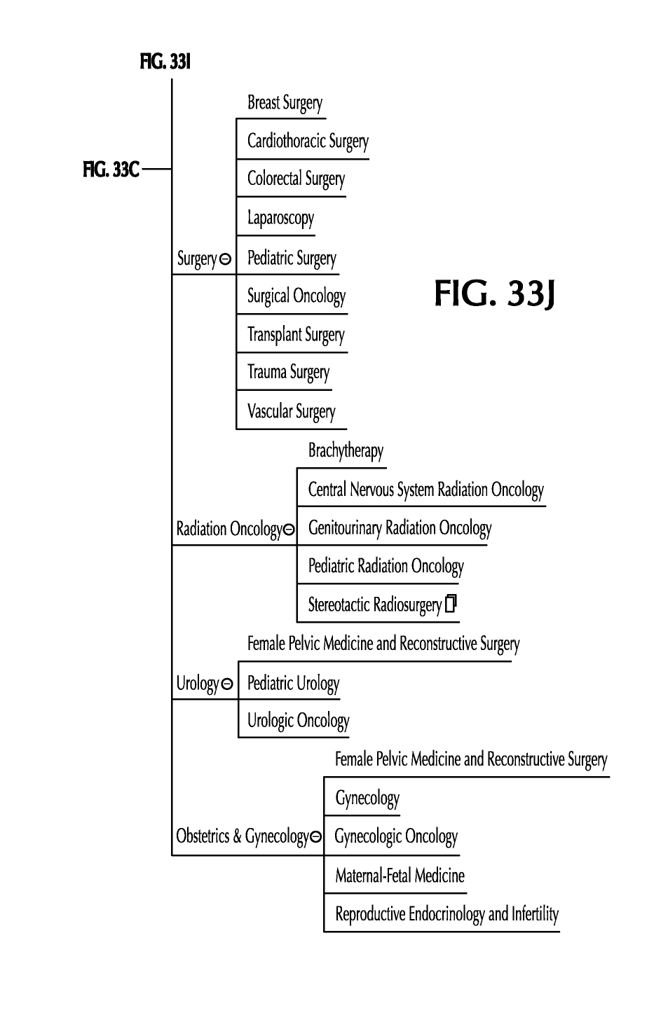

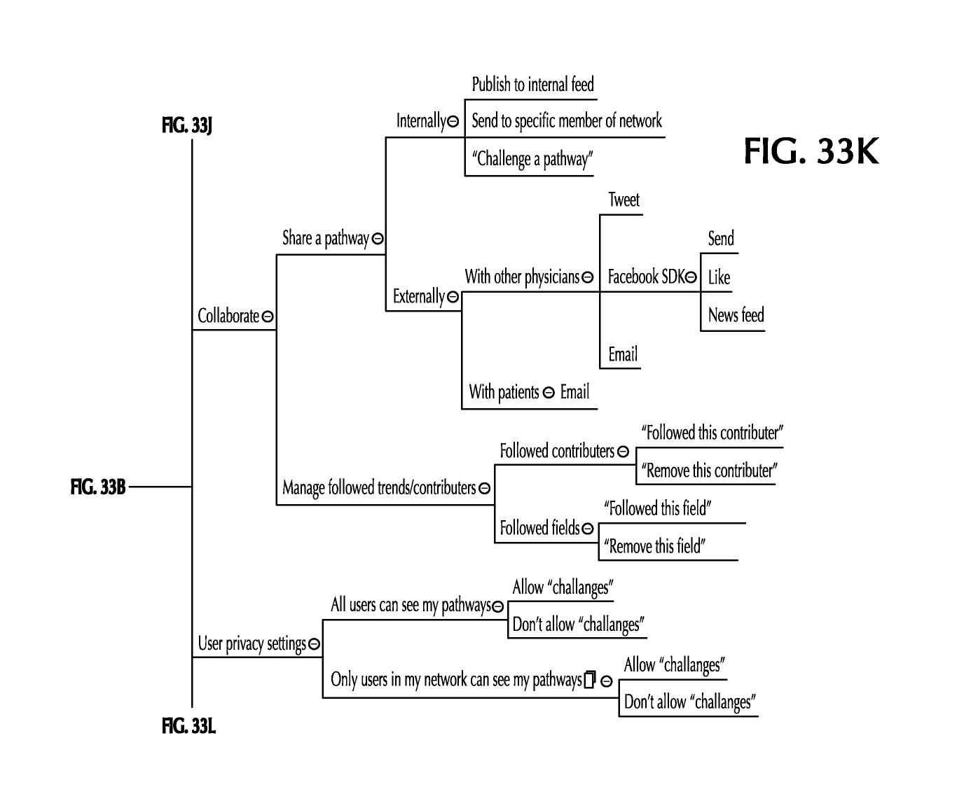

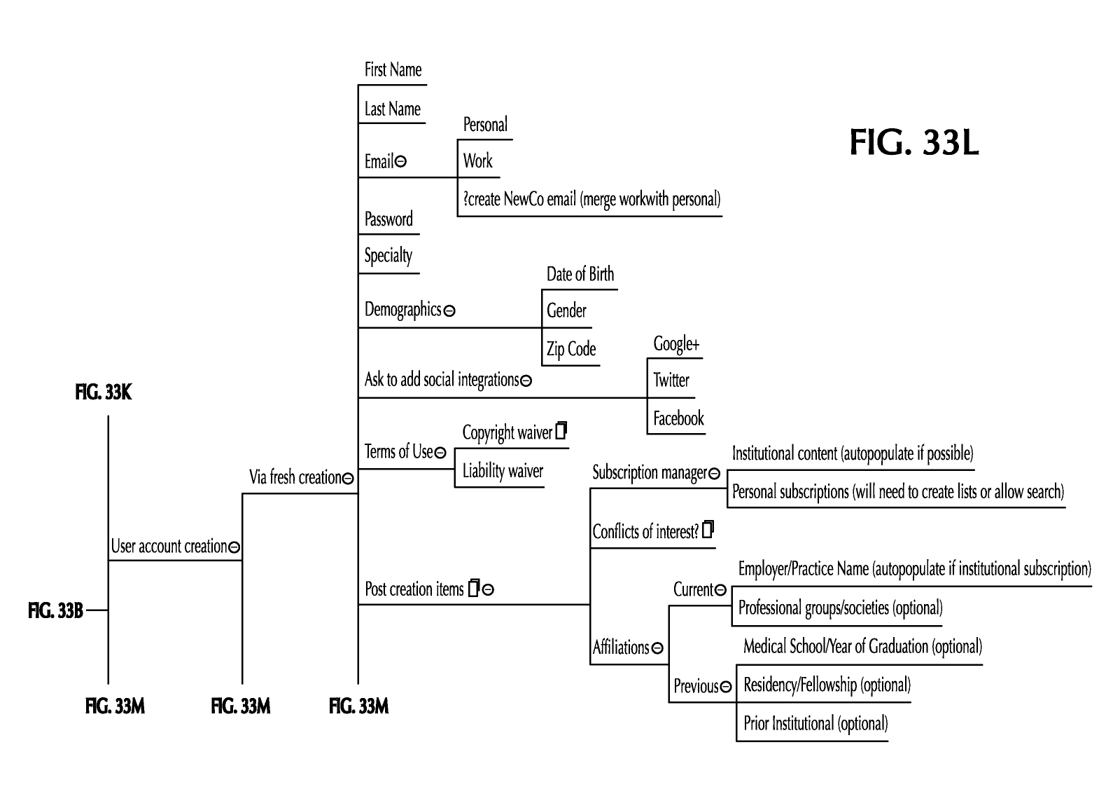

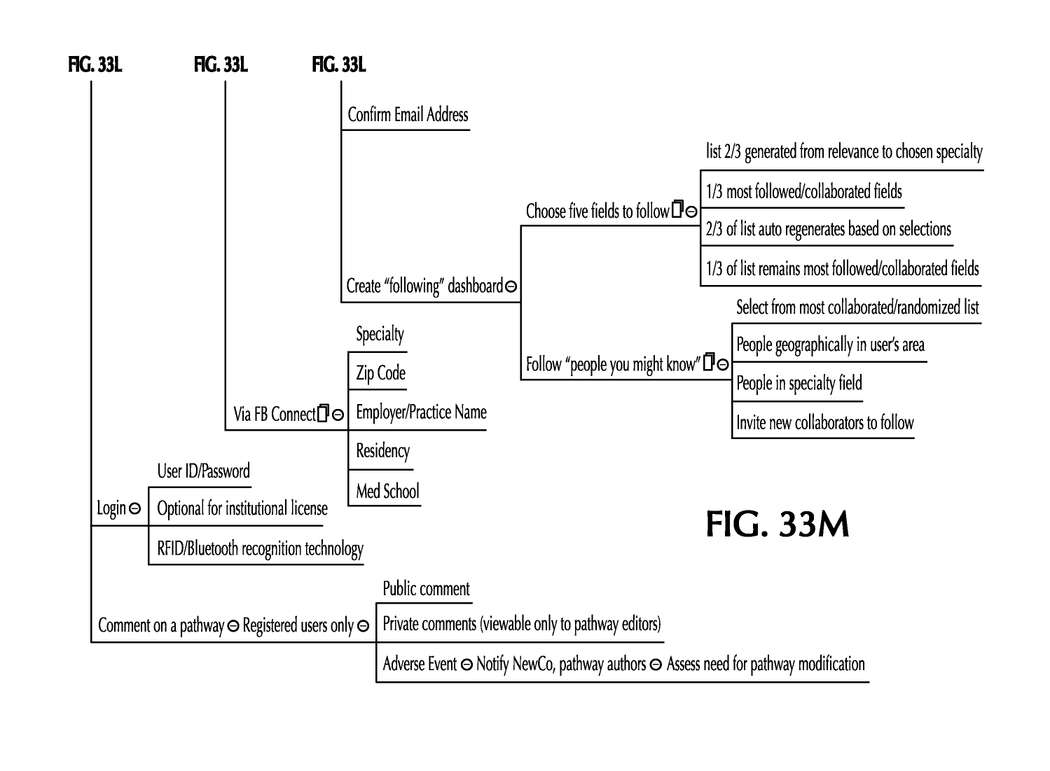

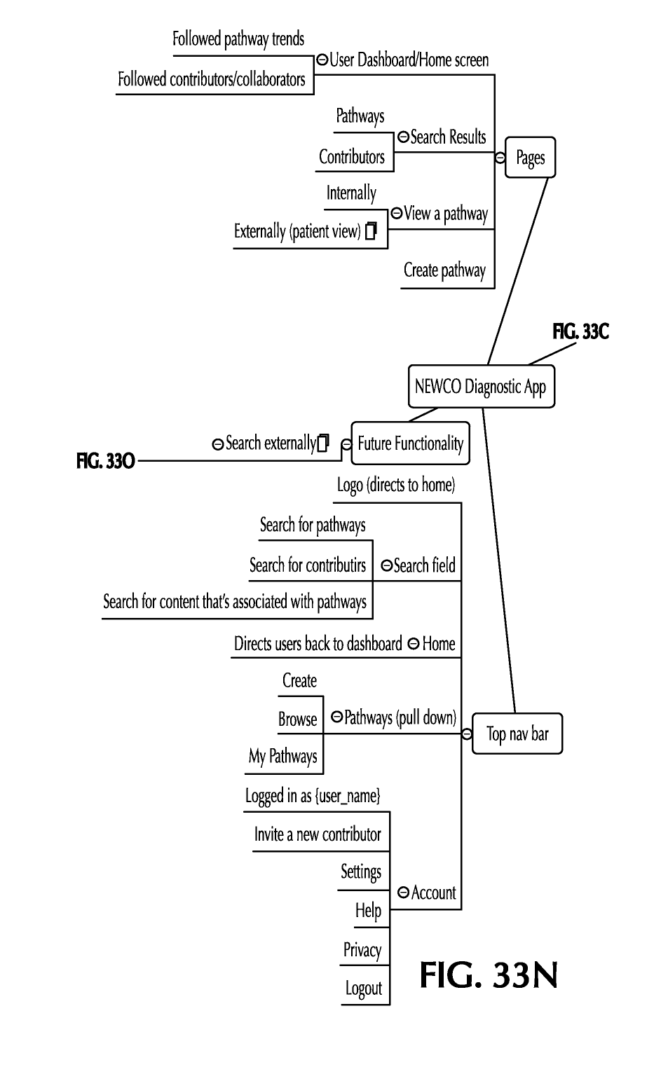

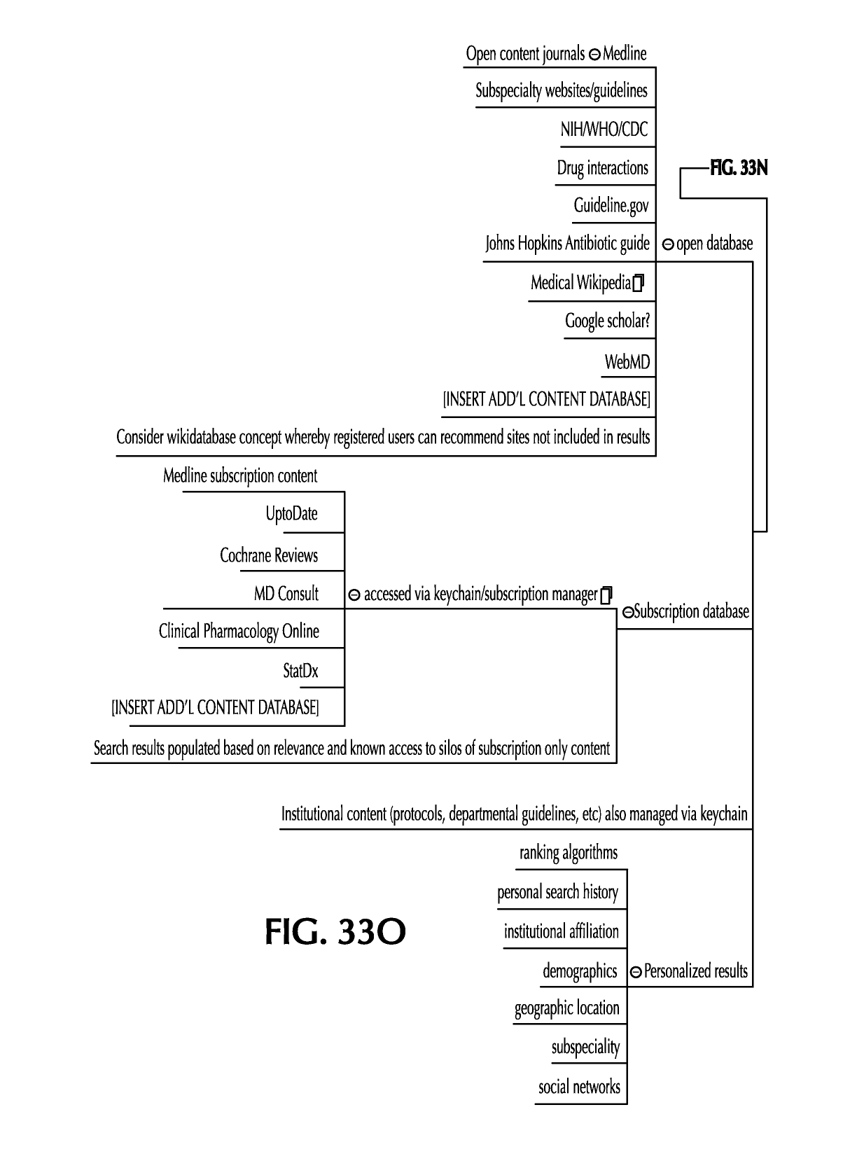

Embodiments of the present invention provide an improved Platform 105 for clinician 101s and others to collaborate in the building of decision making algorithms or creation, use or management of collaborative clinical pathways. In some alternatives, the Platform 105 may provide users with the ability to use “Drag and Drop” techniques as illustrated in FIGS. 2-8 and 11-22 for the development or modification of clinical pathways.

The Platform 105 may include components for the creation and consumption of graphical pathways with underlying databases. The creation and discovery of pathways may occur in a centralized or decentralized, web-based platform and database. Pathways may be developed through a graphical, drag-and-drop interface, allowing the user to see a visual representation of the underlying relational data records. For example, a user may add one or more graphical nodes to a clinical pathway by dragging and dropping a new graphical node from a toolbox within the Platform 105 into a designated target area. In some alternatives, the user may be able to create a relational data record between nodes by dragging and dropping a new node into the target area of an existing node. The relational data record created by this action may establish a parent to child relationship between nodes, the existing node may be the parent node and the new node may be the child node.

In some alternatives, a user may be able to edit textual content of a node through the Platform's GUI. The edited textual content may be stored as an object in the Platform's database. In some alternatives, the textual content for a node may be retrieved using live search technology to query a database of clinical terms and their variants, while the user is typing the textual context. In some alternatives, the textual content may include a selected variant and one or more clinical diagnosis codes. In some alternatives, the Platform 105 may recommend appropriate textual content and/or clinical term variants to a user based on similarities in the intra node relational data in a database. For example, the Platform 105 may compare similar nodes from one or more pathways to assist the user with recommending similar relationships for the current node that a user may edit. In some alternatives, the user may locate pertinent evidence to support the textual content. This pertinent evidence may be stored as a relational record to the textual content. In some alternatives, the Platform's GUI may utilize various asynchronous AJAX-based HTTP requests (“POST, GET, DELETE, PUT”), which may allow the user to manipulate underlying relational data without leaving the current Platform 105 GUI.

In some alternatives, the underlying relational databases may contain records associating specific nodes within pathways, establishing parent to child relationships. These intra pathway relationships may be used to process semantic search queries by users to deliver targeted and relevant search results. For example, the Platform 105 may be able to deliver user specific pathways which contain the node to node relationship “headache+fever” by querying the relational database for relationships between nodes within pathways that contain the query string.

Pathway nodes may have associated content such as images, videos, external links, cited evidence, published journal articles, related guidelines from subspecialty societies or governments, user comments, institutional protocols, coding terminology (e.g. current versions of the International Statistical Classification of Diseases and Related Health Problems (“ICD”) codes, of the Systematized Nomenclature of Medicine (“SNOMED”) codes or current versions of the Current Procedural Terminology (“CPT”) codes), and links to additional pathways which reside in the Platform's database. This additional content may be added and manipulated by the contributing user through asynchronous JavaScript and extensible markup language (“XML”) (“AJAX”) requests. The Platform 105 may present the user with a GUI to add various files to a pathway node from various sources, including local storage on the computers 102. After the user uploads the desired file, the Platform 105 may generate an appropriate relational data record and provide the user with a URL to locate the updated file. The Platform 105 may provide the user with an interface to add cited evidence and published literature to a node. In some alternatives, the interface me be an API based integration with the National Library of Medicine's PubMed service. In some alternatives, the user may locate the cited evidence or published literature by querying the PubMed API through the Platform 105 with a variety of query types. The PubMed API may parse any received record set, which may be in a JSON-based format or an XML-based format. The Platform 105 may display the record set information in an organized fashion to the user. The user may then select the items from the record set to add to the pathway node via AJAX. The Platform 105 may then generate the appropriate relational record in the database.

Finding and Ranking a Pathway

The Platform 105 may allow for users to search for specific pathways using semantic keywords and strings and be presented with relevant and accurate search results. In some alternatives, the search results may be ranked and organized via a method of user feedback. For each observed user interaction with a given pathway search result page, the Platform 105 may promote the position of a result the user may have interacted with during subsequent searches by other users. Over time, this implicit feedback loop may provide more accuracy in the search results. In some alternatives, the search results may be ranked and organized based on data collected from previous Platform 105 queries, both by a specific user or by other users of the Platform. In some alternatives, the search results may be ranked and organized based on data derived from the association of the user with networks available on the Platform. In some alternatives, the search results may be ranked and organized based on data derived from the user's subscriptions to pathways in the system. In some alternatives, the search results may be organized by the previous pathways which the user has navigated in the Platform. In some alternatives, the search results may be ranked in part by data collected from usage data by all Platform 105 users, such as the number of times that a pathway may have been accessed by the Platform 105 users; time the Platform 105 users may have spent browsing a particular pathway; the number of Platform 105 users that may be subscribed to a pathway; and the number of times the Platform 105 users may have copied or personalized a pathway. In some alternatives, the search results may be ranked in part by explicit positive or negative user ratings. In some alternatives, the search results may be ranked by a sentiment analysis of user submitted comments. In some alternatives, the search results may be ranked in part by the number of time a pathway has been referenced by other pathways. In some alternatives, the search results may be ranked in part by the internal rankings of pathway contributors. The pathway contributors may be ranked by metrics, such as the number of pathways published on the Platform; the number of subscribers to those pathways; and the number of times a given contributor's pathway has been copied within the Platform. In some alternatives, the search results may be ranked in part by the number of nodes contained in a pathway. Pathways with a higher number of nodes, with a log based growth rate, in some cases may be ranked higher. In some alternatives, the search results may be ranked in part by an analysis of similarities between individual users. Similar users may be grouped based on explicit and implicit signals. Search results may be served on an individual basis according to the broader group's desires. In some alternatives, the search results may be ranked in part by historical user usage data from historical versions of pathways. As a pathway has changed over time, usage data may vary and may therefore provide insight as to how relevant a particular pathway may be at certain points in time (e.g. a pathway that may have been extremely popular or one that may have become extremely popular may be more or less relevant at present).

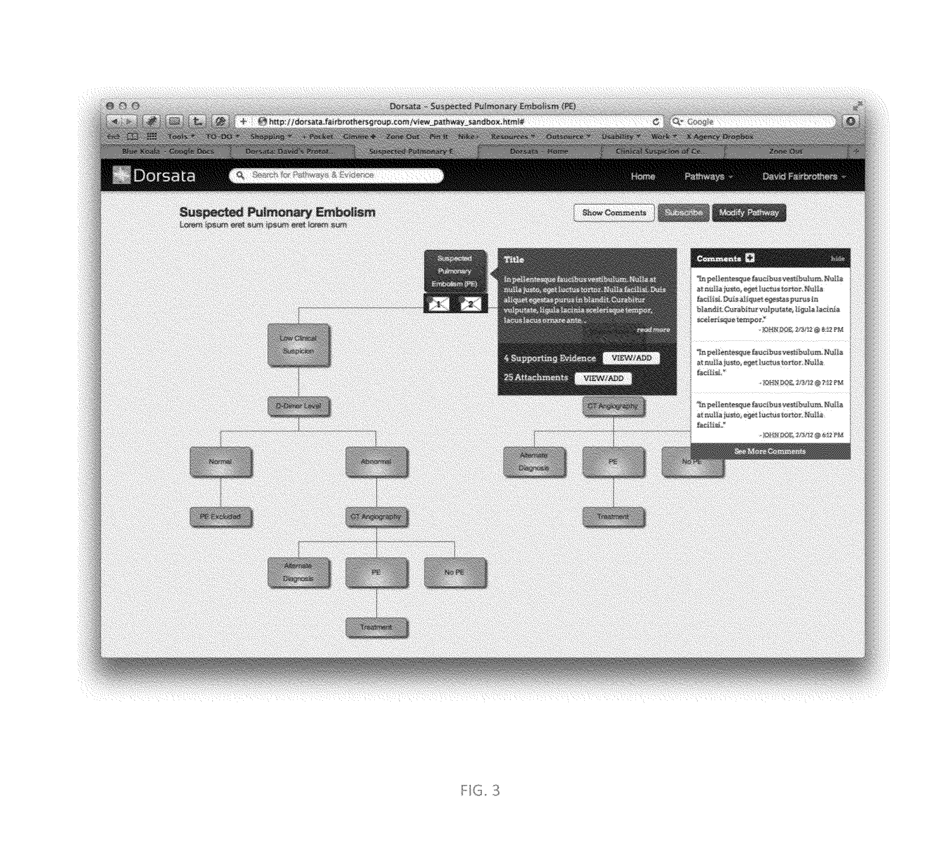

The Platform 105 may be engineered to deliver search results that collect and leverage data from a number of sources, both implicit and explicit, to deliver hyper accurate and relevant pathways. For example, a user may submit the following query to the platform “child+headache+fever” and the Platform 105 may return results that contain one or all of the terms in the query. In some alternatives, a user or third-party application or database may submit data or algorithms as a search query to the Platform. The Platform 105 could be used to ask the user or a third party application to input additional relevant information as they actually see a patient based on existing pathways in the Platform. For example, a clinician 101 may enter “suspected pulmonary embolism” into a query field available on the Platform. Using data from a clinical pathway in the Platform 105 as illustrated in FIG. 3, the Platform 105 may prompt the clinician 101 for additional information, such as D-dimer level, estimated clinical probability of PE, prior imaging studies, or other information related to the diagnosis of pulmonary embolisms using checkboxes, radio graphs, buttons, text fields or any conventional data input field.

Because the Platform 105 may allow for user-created pathways and the contained nodes to be associated to medical terminology and codes, the Platform 105 may allow for users to see the variance between similar pathways in a visual manner as well as the ability for users to see the evolution of a particular pathway's development over time in a visual manner by using various version tracking mechanisms. For example, individual nodes inside of pathways may have different background colors, which may be representative of node types (e.g. procedure, diagnostic test, diagnosis etc.) or different shapes (e.g. square, circle, triangle) to visualize node types (e.g. procedure, diagnostic test, diagnosis etc.). Node colors and shapes may be selected by the user or determined based on analysis of the node's content by the Platform. The Platform 105 may determine the colors and shapes of individual nodes based on the underlying data associated with each particular node. This underlying data may be derived from the current versions of ICD, SNOMED, and CPT codes. In some alternatives, the colors and shapes of the nodes may be used to visualize how a node in specific pathway compares with the nodes in a similar pathway. In some alternatives, the colors and shapes of the nodes may be used visualize the individual contributions by specific users to a collaboratively developed pathway (i.e. a pathway that has been edited by numerous users). In some alternatives, the colors and shapes of the nodes may be used to visualize how the nodes within a pathway have changed over time. Varying colors and shapes may show nodes that have been recently added or modified and other colors may show nodes that may not have change for a certain amount of time. For example, the user may be able to layer multiple pathways on top of each other, where similarities are distinguished in one series of shapes and/or colors and differences are displayed in other shapes and/or colors. One pathway may suggest a CT Angiography at a certain point in the pathway and another may suggest a D-Dimer Test. These differences in data may be visualized using colors and/or shapes. Two or more pathways may be compared by merging the pathways and using colors to highlight differences (e.g. yellow & blue) and similarities (e.g. green) between the various steps within pathways. This comparison may be used to rapidly demonstrate where two or more pathways diverge such that a clinician 101 may identify areas where there is general consensus versus disagreement in the approach to a clinical problem.

In some alternatives, the various steps of a clinical pathway or nodes of a clinical pathway may be associated with one or more medical terminology or translated into one or more data formats for the exchange of data with other electronic clinical systems. The Platform 105 may allow for the direct, node to node navigation through pathways through a variety of channels such as a web browser, a mobile device, the EHR, or any other third-party application. The Platform 105 may provide a web service or API, such as the RESTful API through which third-party applications may access and manipulate pathway node content. Third party applications may be able to access pathway content using standard. HTTP-based requests.

Networks

In some embodiments of the invention, the Platform 105 may provide users with the ability to create a community of one or more custom networks. Custom networks may include entities, such as a hospital system, a subspecialty society, clinical department, university, medical school, research entity or clinical practice group. In some alternatives, the custom networks may have their own security, permissions, users, administrators and private clinical pathways. In some alternatives, the custom networks may have publicly available pathways. In some alternatives, the custom networks may be share by one or more entities. These networks may serve as pathway working groups, in which multiple pathways may be edited and shared with other network members. These networks may be able to be designated as private (“only open to users who have been specifically invited by network administrators”) or public (“open to all users, system-wide”).

In some alternatives, the Platform 105 may provide users with several ways of inviting or adding other network members and managing network memberships. In some alternatives, the Platform 105 may allow a user to designate a specific email address web-domain (e.g. ‘google.com’) as approved for access to a network. For example, if a user was to add “@hitchcock.org” as an approved domain to access his network, all users with a valid “@hitchcock.org” address will be granted access to that network. The Platform 105 may provide an automatic email verification mechanism through which an auto-generated email, which contains a uniquely generated hyperlink, is sent to the requesting user. Once the user clicks the uniquely generated hyperlink, he is directed to a page within the Platform 105 which confirms his network membership.

In some alternatives, the users may be able to designate privacy settings for pathways. These privacy settings may be used to control access to the pathway by other users. For example, a pathway may be published to specific networks and/or working groups and/or to specific users. If a particular user has not been granted access to a specific pathway, they may not be able to view the underlying data, relationships, and content contained in the pathway. This user may be able to request access to the restricted pathway. If the request is granted by a pathway contributor, then the user may be able to access the restricted pathway.

Updating a Pathway

In some alternatives, as illustrated in FIGS. 11-22, the Platform 105 may provide users with the ability to modify a new or existing clinical pathway by adding nodes in an ad-hoc fashion to account for any unknown or unpredictable conditions that may arise with a particular patient or patients. In some alternatives, a user may be able to delete nodes from a pathway by dragging and dropping the node into the Platform's deletion target area. In some alternatives, the Platform 105 may algorithmically encourage the collaborative modifications and additions to pathways by networks of users. In some alternatives, Updates to a specific pathway by a user may be collected and delivered to all other users who may be associated with that pathway through network association, pathway subscription, or by being an approved collaborator. The collection and delivery may occur through an organized interface that may list the updates chronologically. A user who may be building the pathway may be able to associate long-term or short-term patient health outcome data and patient cost data to pathways. The user who may be viewing a pathway may be able to view patient outcomes and cost data which is associated to that pathway.

In some alternatives, the Platform 105 may store and organize data regarding the evolution of pathways, which reside in the Platform's database. The Platform 105 may store data items on a node by node basis, storing historical textual content, and associated items (e.g. videos, images, documents, cited evidence etc.) In some alternatives, the Platform 105 may store usage data per pathway or per pathway version. This means that each version of a given pathway may have a specific record of how much user interaction may have occurred within each version

In some alternatives, the user may be able to copy steps from one pathway to another pathway in the Platform. For example, when a user changes a step, adds/deletes content, etc. to a node, the same step, content, etc. may be added/deleted to the companion node(s) in the “mirror image” or “cloned” branch. In another example, a trauma pathway on the Platform 105 may recommend blood transfusions for patients with splenic rupture and hemodynamic instability or low hemoglobin on presentation. A clinician 101 in a patient encounter, with a patient whose religious or other obligations may prevent them from accepting a blood transfusion presents a challenge. The Platform 105 may provide the clinician 101 the ability to add a branch to the existing pathway—“Contraindication to blood transfusion” and create an alternate management pathway for the patient. Due to the nature of the Platform, this new pathway, based on the clinician's 101 user settings, may now be readily available to other users of the Platform.

Collaboration on a Pathway

Multiple users may have privileges to edit, modify, update, and distribute certain pathways which reside in the database. In this manner, the Platform 105 may drive collaboration by delivering updates and changes to pathways to the associated users through pathway updates. When an approved contributor changes a pathway, such as adding new nodes, associating new supplemental content, and more, the Platform 105 may generate a pathway update record asynchronously that logs, among other things, the time the change was made, the user who made the change, and specifically what change was made. The Platform 105 may organize and display pathway updates by pathway on browse pathway lists. The Platform 105 may asynchronously store which updates have been seen by which users. The Platform 105 may also provide functionality for users to invite additional collaborators to edit certain pathways. For example, a specific user may desire to work on a single pathway with multiple colleagues. To achieve this, the user may simply invite the desired colleagues using a tool provided by the Platform. This tool may provide an email-based invitation feature. The user may enter the desired colleagues' email addresses and a uniquely identifiable link would be sent to them by the Platform. When the colleague clicks the link, he or she may be able to access the content by signing up for a Platform 105 user account or log in with an existing user account. After accepting the invitation, the colleague may have access to the Platform 105 to modify the pathway. All changes in the particular pathway may be seen by other approved contributors.

Using Outcome Data from the EHR for Evaluation for Pathway Efficacy

In some embodiments of the invention, outcome data on pathway use may be obtained through the interface with the one or more EHR 104 systems. For example, if the user would like to know if the “Dartmouth Hip Pain Pathway” has been used 400 times during the last 6 months at 12 institutions. An interaction with the EHR 104 may provide the following outcome data, 75% of patients were managed non-operatively with an additional 25% of patients undergoing hip replacement surgery with an average cost of $26K per patient. In some alternatives, the user may be able to populate a patient's electronic medical record by clicking through a graphical pathway during the course of care. The Platform 105 may also use pathway outcome data as a means to reorder and re-rank pathway search results. For example, a user may query the Platform 105 for a pathway to evaluate a patient for a pulmonary embolism. The Platform 105 may display some matching pathways ahead of others according to the pathway's outcome data which has been derived from the EHR. To compare two similar pathways, the Platform 105 may use any underlying or mapped medical terminology to query the Unified Medical Language Service (“UMLS”) for related concepts and codes. In this manner, the Platform 105 is able to compare pathways that may be mapped to multiple data standards. For example, one user could develop a pathway and associate specific nodes to ICD codes. Another user could have developed a similar pathway using SNOMED-CT codes. The Platform 105 may use the ICD code from the first pathway to send an HTTP request to the UMLS requesting all related codes from other data standards such as SNOMED-CT. If the response contains SNOMED-CT codes, the Platform 105 may be able to make an association between the two similar pathways.

In some alternatives, the Platform 105 may provide the user with costs associated with each version of a clinical pathways or similar pathways, which the user may compare to decide on a cost effectiveness of a method of treatment. In some alternatives, the Platform 105 may associate codes with a MEDICAID/MEDICARE payment mechanism, such as incentive payments or a commercial insurance pre-negotiated payment amount for a diagnosis to assist the user in making decisions about whether a selected clinical pathway may be approved be either MEDICAID, MEDICARE or the patient's insurance provider. In some alternatives, the Platform's 105 pathways may be used as a basis by which medical providers may be financially incentivized for using best-practices. In other words, a medical provider may receive a 20% premium to the cost associated with a patient's care because they may have used the Platform's 105 pathways as a basis for diagnosing and treating the patient. The Platform's 105 may also provide support for specific bundled payments, which may be negotiated for pathway driven care. For example, a pre, intra, and post-operative pathway for a certain condition may have a very specific cost associated with it that MEDICARE or a private insurance could pay as a bundled payment. In some alternatives, the Platform's 105 pathways can help providers understand, in real-time, if they're ordering things that are actually reimbursable by a patient's insurance. Other uses for the Platform

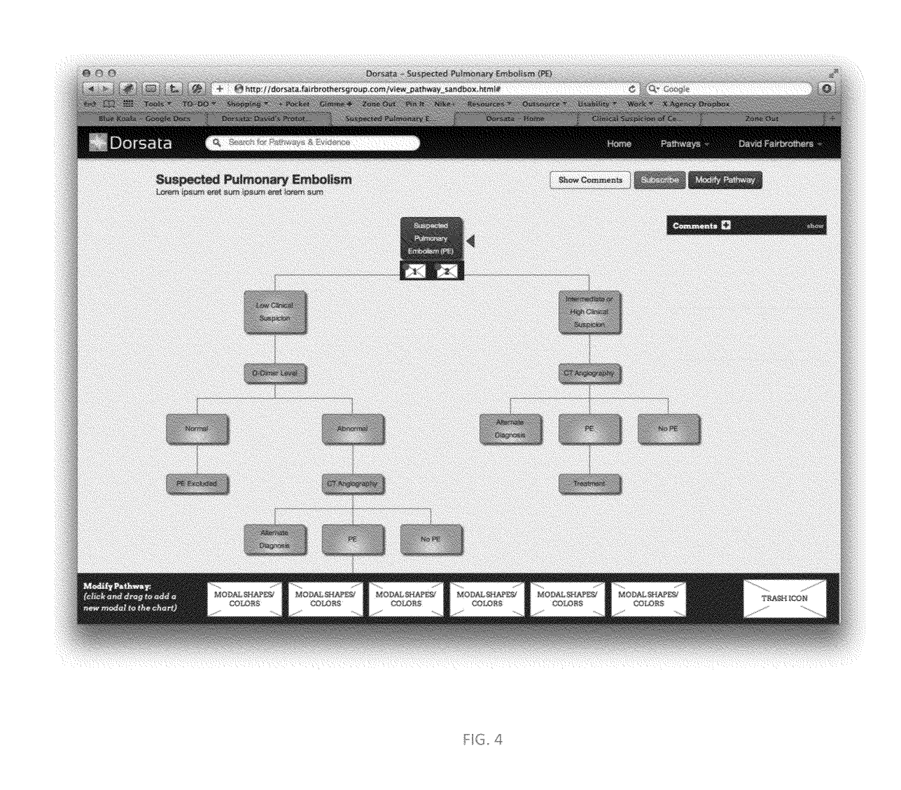

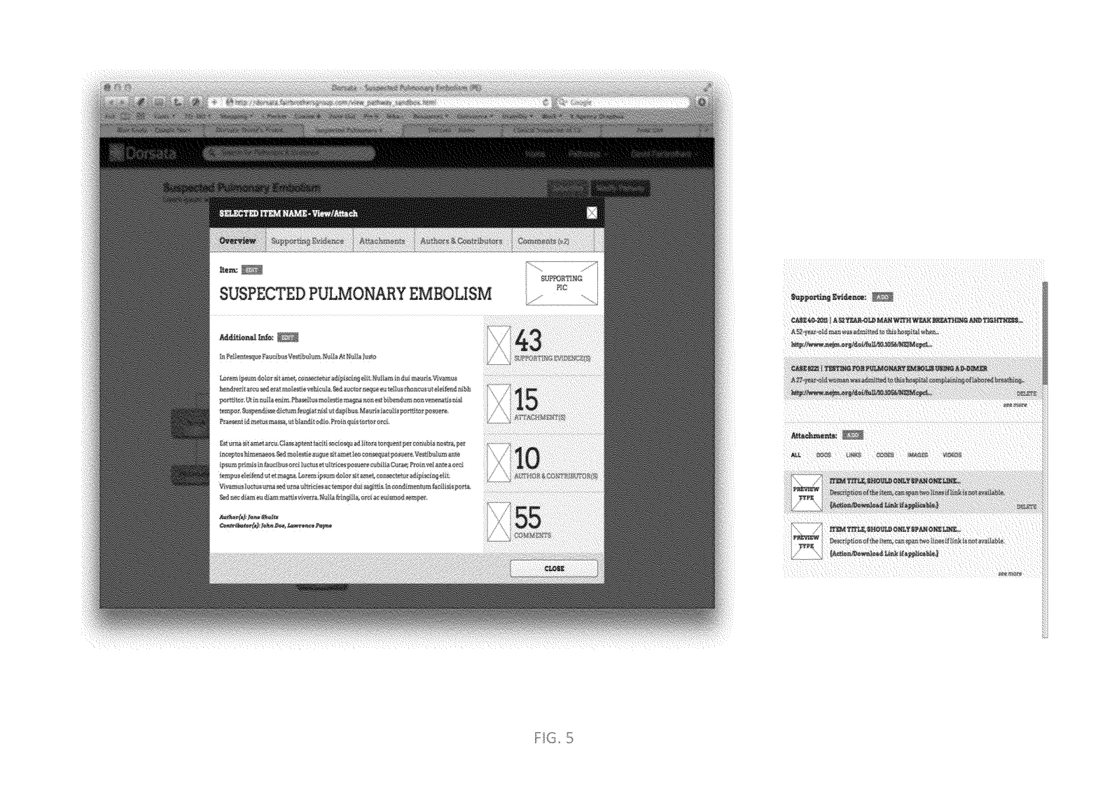

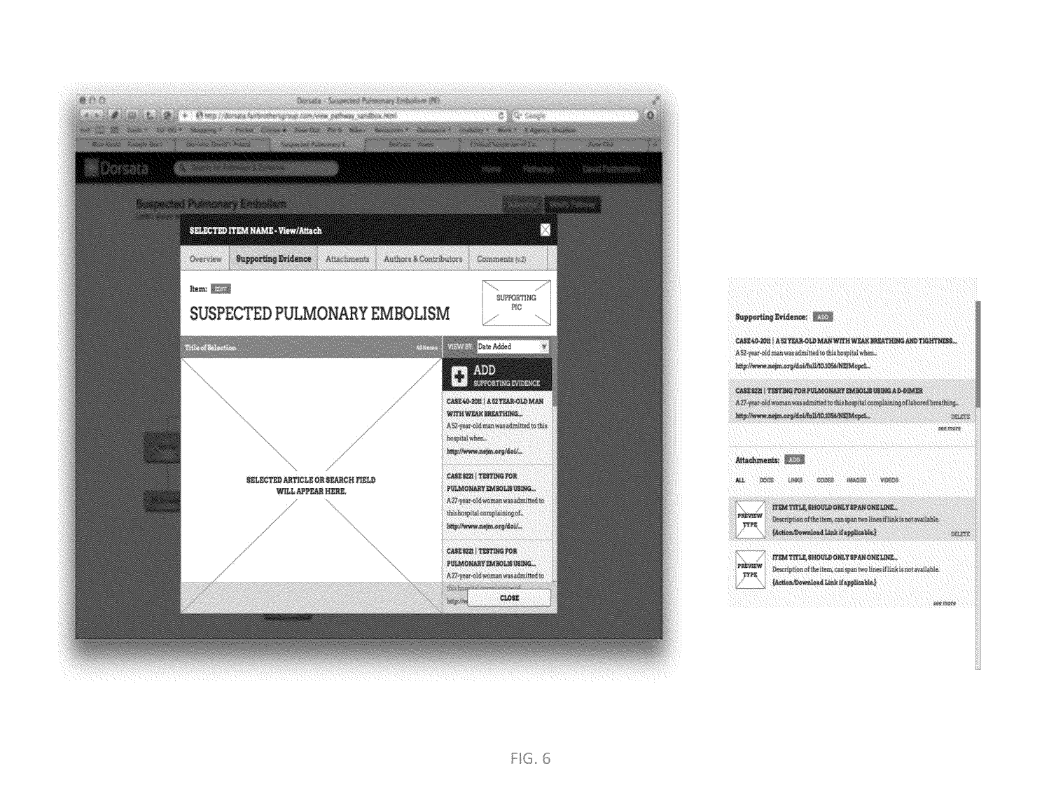

In some embodiments of the invention, the user-generated pathways created with the Platform 105 may be used to build a computerized decision-support system. For example, as illustrated in FIG. 4, in the field of radiology, users of the Platform 105 or computerized decision-support system may build a diagnostic algorithm for cerebellopontine angle (“CPA”) lesions. As the algorithm is used and validated in clinical practice, the Platform 105 may eventually be able to use data from this algorithm to formulate a complementary computer-based system to assist in detection of imaging pathology, i.e. train a computer to localize the cerebellopontine angle on MRI studies, assess for asymmetry or mass lesions, then apply the algorithm in assessing the lesions signal characteristics to formulate an appropriate differential diagnosis. Over time, users may attach relevant content or other data to the clinical pathway, which may be the basis for the algorithm and with integration to the EHR 104, results may be associated with the ultimate findings at pathology. This data could then be used to populate computer detection algorithms which might automate some of the processes of image interpretation using conventional image query techniques. In some alternatives, the Platform 105 may use conventional syntaxes; standardized language or data interchange formats to translate the language of the pathways that the clinicians 101 build into one or more standardized language used to construct medical logic modules which can be used to automate decision support. In some alternatives, the Platform 105 may harnesses the social network to create a system which has the ability to rapidly learn and disseminate best practices.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A computer-implemented method for utilizing dynamic clinical pathways for facilitating clinical order set entry, the method comprising the steps of:
receiving initial clinical assumption from an electronic health record;
receiving physician identifier;
querying one or databases using the initial clinical assumption and physician identifier;
compile a set of one or more clinical pathways related to the initial clinical assumption and physician identifier;
returning the set of one or more clinical pathways to the electronic health record;
receiving a chosen pathway from the set of one or more clinical pathways;
logging the chosen pathway;
receiving choice of a node with the chosen pathway;
logging the choice of node;
capturing a clinical order set code;
if necessary, receiving choices of additional nodes and logging the additional choices of nodes and capturing associated clinical order set codes for the additional choices of nodes until the chosen pathway is complete; and
returning a compilation of clinical order set codes.

2. The computer-implemented method of claim 1, wherein the initial clinical assumption comprises symptomatic queries.

3. The computer-implemented method of claim 1, wherein the initial clinical assumption comprises assumptions regarding potential diagnosis by a physician.

4. The computer-implemented method of claim 1, further comprising receiving a patient identifier in combination with the initial clinical assumption and physician identifier in the querying.

5. The computer-implemented method of claim 1, further comprising receiving an encounter identifier and using the encounter identifier in combination with the initial clinical assumption and physician identifier in the querying.

6. The computer-implemented method of claim 1, wherein the set of one or more clinical pathways are ranked prior to returning.

7. The computer-implemented method of claim 6, wherein the ranking is based at least in part on the physician identifier.

8. The computer-implemented method of claim 1, further comprising receiving data regarding patient admission prior to receiving initial clinical assumption.

9. The computer-implemented method of claim 1, further comprising collecting patient biographic or demographic data prior to the receiving initial clinical assumption.

10. The computer-implemented method of claim 1, further comprising collecting information regarding a chief complaint of a patient.

11. The computer-implemented method of claim 1, further comprising receiving The computer implemented method of claim 1, further comprising switching from a selected clinical pathway to a second clinical pathway as suggested by the selected clinical pathway.

12. A computer-implemented method for identifying a patient's previous clinical pathways during a new patient encounter, the computer-implemented method comprising the steps of:
receiving a request from a third-party system for one or more clinical pathways associated with a first patient encounter, wherein the request contains a token generated by the third-party system;
analyzing the token to identify a unique identifier associated with a patient's electronic health records;
updating the received request with the identified unique identifier;
submitting the updated request to one or more clinical pathway databases;
ranking results received from the one or more clinical pathway databases using at least one ranking criteria; and
transferring the ranked results to the third party system for display to a user.

13. The computer-implemented method of claim 12, wherein the token contains identifiers selected from a group consisting of: the unique Electronic Health Record identifier of a patient, a unique identifier identifying a clinician, a unique identifier identifying a clinician's location, medical specialty area, desired networks by a clinician and combinations thereof.

14. The computer-implemented method of claim 12, wherein the ranking criteria ranks clinical pathways associated with the unique identifier higher than other clinical pathways in the results.

15. The computer implemented method of claim 12, wherein the third-party system is selected from the group consisting of electronic health record systems, electronic medical record systems, other health care databases and combinations thereof.

16. The computer-implemented method of claim 12, wherein the ranking criteria is based on usage data for the one or more clinical pathways.

17. The computer-implemented method of claim 16, wherein the usage data is selected from the group consisting of: number of times the one or more clinical pathways has been accessed, network memberships and affiliations for the one or more clinical pathways, user subscriptions to the one or more clinical pathways, time spent browsing the one or more clinical pathways, number of time the one or more clinical pathways have been used to update other pathways, internal rankings of the one or more clinical pathways by contributors, number of nodes contained in a pathway, explicit and implicit signals, historical usage data and combinations thereof.

18. The computer-implemented method of claim 17, wherein the internal rankings is selected from the group consisting of: number of the one or more clinical pathways published, number of subscribers to the one or more clinical pathways, the number of times the one or more pathways have been used to update other pathways and combinations thereof.

19. The computer-implemented method of claim 17, wherein the historical usage data indicates the relevance of the one or more clinical pathways at a particular point in time.
